(19) United States
(12) Patent Application Publication
(10) Pub. No.: US 2019/0014954 A1
(43) Pub. Date: Jan. 17, 2019

(54) DOMESTIC APPLIANCE COMMUNICATION SYSTEM

(71) Applicant: simplehuman, LLC, Torrance, CA (US)

(72) Inventors: Frank Yang, Rancho Palos Verdes, CA (US); David Wolbert, Redondo Beach, CA (US); Guy Cohen, Marina Del Rey, CA (US); Paul Hamburger, Los Angeles, CA (US); Sanam Lahijani, Los Angeles, CA (US); Nicholas Swenson, Yorktown, VA (US); Chao He, Los Angeles, CA (US); James Allen, Boston, MA (US)

(21) Appl. No.: 16/134,399

(22) Filed: Sep. 18, 2018

Related U.S. Application Data
(63) Continuation of application No. 14/741,204, filed on Jun. 16, 2015.
(60) Provisional application No. 62/013,924, filed on Jun. 18, 2014.
(60) Provisional application No. 62/120,245, filed on Feb. 24, 2015.

(51) Int. Cl. A47K 5/12; G06Q 30/06; B65F 1/06

(52) U.S. Cl. CPC A47K 5/1217; B65F 1/06; G06Q 30/0601

(57) ABSTRACT

The present disclosure describes a domestic appliance communication system that provides consumers with the ability to remotely access information about their domestic appliances, and in particular domestic appliances which utilize consumable resources which may need to be periodically replaced or replenished. The domestic appliance communication system may periodically receive status information from the domestic appliances owned by a consumer or household and provide updated status information to the consumer, either on demand or via alerts triggered in response to certain events. The present disclosure also describes implementations and improvements which may be made to domestic appliances in order to provide periodic measuring and transmitting of status information to a remote system, such as the domestic appliance communication system.

### CROSS-REFERENCE TO RELATED APPLICATIONS

This application is a continuation of U.S. patent application Ser. No. 14/741,204, filed Jun. 16, 2015, which claims priority to U.S. Provisional Application No. 62/013,924, filed Jun. 18, 2014, and U.S. Provisional Application No. 62/120,245, filed Feb. 24, 2015, the disclosures of all three of which are hereby incorporated by reference herein in their entireties.

### BACKGROUND

Consumers today use a wide variety of household products and domestic appliances which often utilize refillable or replaceable items. Soap dispensers require soap refills, trash cans need replacement trash bags, lighted vanity mirrors eventually need replacement light bulbs or LEDs, and a variety of battery-powered household products require regular recharging or replacement batteries. While consumers may enjoy cost savings and some convenience offered by using these types of domestic appliances, they may also have a difficult time keeping track or remembering which appliances need refills or replacements of these consumable resources, or may not have a refill or replacement readily available when the consumable item runs out. By the time the consumer makes a trip to a market or retail outlet to buy various goods, he or she may not remember which items need refills, or experience frustration to return home only to have a consumable resource run out soon after making the trip.

### SUMMARY

Some embodiments of the present disclosure describes domestic appliance communication systems that provide a consumer with the ability to remotely receive and access updated status information about consumable resources for his or her domestic appliances, such as while away from home or otherwise unable to directly access those domestic appliances. For example, while shopping, away from home, or otherwise “out and about” the consumer may wish to check whether a particular domestic appliance needs a refill or replacement of a consumable resource (for example, whether the consumable resource is running low or projected to run out soon). The domestic appliance communication system may provide the consumer with the ability to perform this check on demand, or provide the consumer with real-time alerts or notifications, such as when the consumer is at or near a retail location where a particular refill or replacement item may be purchased.

In some embodiments, a consumer shopping at a supermarket may wish to know whether a bathroom soap dispenser at home needs a soap refill. Unless the consumer happened to check the bathroom soap dispenser recently or before leaving home, the consumer may not have any easy way of knowing whether he or she needs to buy a soap refill. The domestic appliance communication system may allow the consumer to access, via for example a mobile application or website using his or her smart phone, updated status information about how much soap is remaining in the bathroom soap dispenser when the status information is needed, such as to make a decision, so that the consumer can make a determination about whether to buy the soap refill. In some embodiments, the consumer may not even remember or even think about checking whether he or she needs a soap refill, and thus in some instances the domestic appliance communication system may be configured to alert the consumer when the soap refill may be needed, or when the consumer is nearby a location (determined, for example, based on geo-location data received from the consumer's mobile device) where the soap refill may be purchased. In some instances, the domestic appliance communication system may automatically add the soap refill to a shopping list for the consumer, or automatically submit an online order to a retailer for the resource, based on standing instructions from the consumer.

To facilitate providing updated status information about a domestic appliance owned by a consumer (or associated with a household of the consumer) and related consumable resources, the domestic appliance communication system may be configured to receive periodic updates on the status of various consumable resources from the domestic appliance configured to measure or monitor the status of various consumables and transmit status information to a remote system. The domestic appliance communication system may provide (e.g., in a periodic manner) the updated status information to the consumer remotely such as via a wireless communication network and/or via the consumer's smart phone or other mobile computing device. Thus, the domestic appliance communication system may be configured to communicate with any type of domestic appliance that is configured to measure or monitor consumption or one or more other parameters, and to transmit status information to a remote system, such as the domestic appliance communication system. The present disclosure describes some embodiments of domestic appliances that may be configured to provide such functionality in communication with the domestic appliance communication system.

In some embodiments, the domestic appliance communications system as described herein may provide one or more benefits and/or features described herein. One example of an advantage offered by some embodiments of the system is the collection of consumption and/or performance data over time from a consumer, a household, a business, and/or another usage location, and/or from an aggregation of consumers, households, businesses, and/or other usage locations. The collected consumption and/or performance data may be analyzed in order to determine or identify preferences, usage patterns, product performance and/or reliability data, manufacturing and/or sales forecasting by the seller of the product and/or the seller of a consumable resource, and/or any other predictions based upon various domestic appliances used by one or more consumers, households, businesses, or other locations. The domestic appliance communications system may use the analyzed data to, for example, predict based on past usage data and trends, when a particular refill or replacement item may be needed. The prediction may be provided to the consumer before the refill or replacement item may actually be needed, such that the consumer may be able to purchase a refill or replacement item in advance. For example, the consumer may wish to plan a monthly trip to a store in order to buy various household products which may be needed for the entire month. Although a refill may not be needed at the time of the monthly trip, the refill may be needed sometime during the course of the subsequent month. Thus, a prediction that the domestic appliance may need a refill during the subsequent month may be provided so that the consumer may purchase the refill ahead of time.

Usage data, usage patterns, and predicted usage may also be beneficial in other contexts. For example, a domestic appliance may experience a malfunction that prevents transmission or even measurement of a consumable resource. In the absence of recently received status information from the domestic appliance, the domestic appliance communication system may nonetheless use past usage data and/or predicted usage trends in order to notify the consumer that a refill or replacement may be needed. The absence of recently received data may also be used by the domestic appliance communication system to provide an alert or notification to the consumer that the domestic appliance itself may need to be checked for a possible malfunction.

In some embodiments, the domestic appliance communication system may also provide the consumer with purchasing incentives, such as relevant coupons or targeted advertisements, based on the consumer's domestic appliances and related usage data. For example, when providing an alert, notification, or other status information to the consumer, the domestic appliance communication system may also determine and provide coupons or other sales inducements (e.g., notice of a temporarily lowered price), which may be available for various items that may need a refill or replacement. Coupons or advertisements may, for example, be received and/or offered from a manufacturer or retailer.

As mentioned, the domestic appliance communication system may operate in communication with a computing device associated with the consumer, such as a smart phone or other mobile computing device the consumer may typically carry while away from home, a tablet device, and/or a desk-top computer. For example, the consumer may install, on the computing device, an application (or “app”) which enables access to the consumer's domestic appliance status information and related data available from the domestic appliance communication system, or the consumer may access a website which provides remote access to the domestic appliance communication system, or the like. The domestic appliance communication system may receive data from the consumer's computing device, such as GPS coordinates or requests for updated status information, and provide updated status information to the consumer in response.

The domestic appliance communication system may provide various user interfaces for display on the consumer's computing device to present status information and enable the consumer to perform various actions with respect to his or her domestic appliances. For example, the consumer may be provided an option to purchase a refill or replacement item directly from an electronic marketplace or online retailer using his or her computing device. In some embodiments, the consumer may be able to view usage trends, current or recent amounts remaining for one or more consumable resources associated with one or more respective domestic appliances, and/or remotely manage the domestic appliances. For example, a user interface provided by the domestic appliance communication system may provide an indication that a bathroom soap dispenser has approximately a specific amount or less of soap remaining (e.g., approximately 10% or less of soap remaining in a reservoir), and/or an indication or prediction that based on a consumption or usage trend the soap in the soap dispenser may run out or be depleted of soap, or may reach a particular lower level of soap, in or within a specific amount of time (e.g., approximately 2 more days).

In some embodiments, the user interface may provide the consumer with an option to change (e.g., decrease) the amount of soap dispensed by the bathroom dispenser (for example, from 2 ml of liquid dispensed per pump to 1 ml of liquid dispensed per pump), such as to extend the anticipated run-out time in some embodiments. The domestic appliance communication system may receive the updated dispenser amount and in turn transmit the updated dispenser amount to the domestic appliance. As further described herein, the domestic appliance may implement logic or other circuitry which enables the domestic appliance to change the amount of one or more consumable resources (e.g., liquid soap) used in conjunction with one or more functions (e.g., dispense liquid soap) of the domestic appliance.

In some embodiments, a user information system for domestic products (e.g., soap pumps, trash cans, and/or vanity mirrors) can be utilized with, or as a part of, a domestic appliance communication system, or as a separate system. A user information system can be a software system or a combination of a software and a hardware system (e.g., an “app” for a mobile device, a computer program for a desktop or laptop computer; or an app or computer program in combination with a mobile device and/or desktop or laptop computer device). In some embodiments, the user information system can comprise one or more of the following features: (a) a visual display of product information about one or more products in a company's product line; (b) a registration feature to enable a user to register a product electronically, such as by providing the user's identifying information, such as name, address, or email, etc., and identifying information about the product, such as product name, product code, and/or other identifying product features, such as color, size, and/or location and/or name of seller where the product was purchased; and/or (c) an ordering feature to enable a user to order one or more products, or one or more disposables or consumables for use with a product, either in a discrete one-time purchase, or on a recurring, ongoing basis, in a manner that is based upon one or more adjustable predictions of the rate at which disposables or consumables are being used by a user.

As described herein, a domestic appliance may include a variety of devices or objects typically used in a consumer household. Some examples of domestic appliances that may be configured to operate in conjunction with a domestic appliance communication system to provide the features and improvements described herein may include, for example, an electric soap dispenser, an electric trash can, an electric vanity mirror, an electric deodorizer, and the like. As used herein, the term “electric” or any similar term means that the particular domestic appliance is powered by electricity (either by an electric plug and wall outlet or via wireless charging) and/or by battery.

Neither this summary nor the following detailed description purports to limit the scope of protection. The scope of protection is defined by the claims.

### BRIEF DESCRIPTION OF THE DRAWINGS

FIG. 1 is a block diagram depicting an example of an illustrative network environment in which a domestic appliance communications system may operate.

FIG. 2 is a schematic diagram illustrating one example domestic appliance, an electric liquid soap dispenser, in accordance with an embodiment.

FIG. 3 is a logical flow diagram of an embodiment of a process for monitoring the status of a domestic appliance, involving the domestic appliance of FIG. 2.

FIG. 4 is a logical flow diagram of an embodiment of a process for providing domestic appliance status information remotely to a user computing device, involving the domestic appliance communication system of FIG. 1.

FIGS. 5-24 are example user interfaces that may be provided via a web browser or standalone application, such as a mobile application, presenting various domestic appliance management options and information to a user, involving the domestic appliance communication system of FIG. 1 and/or involving a user information system.

### DETAILED DESCRIPTION

Domestic appliances as generally described herein may involve or utilize at least one consumable resource, wherein the consumable resource is consumed, used, or depleted, in whole or gradually over time, in accordance with the ordinary and/or intended function of the domestic appliance, requiring eventual refill or replacement in order for the domestic appliance to continue its ordinary and/or intended function. For example, an electric soap dispenser may have or contain one or more liquid consumable resources that may be depleted or reduced over time, such as soap, lotion, and/or hand sanitizer. Any feature, step, or structure described and/or illustrated in this specification for “soap” or a “soap dispenser” or any similar term should be understood to apply to any type of consumable or liquid and/or any type of liquid dispenser or consumable dispenser. In some embodiments, an electric trash can may have at least two consumable resources that may be depleted or reduced over time: capacity (e.g., how much trash the trash can hold in its interior space) and an amount of trash bags (e.g., for a trash can which provides manual or automatic trash bag replacement when a used or filled trash bag is removed). In some embodiments, an electric vanity mirror may have one or more consumable resources that may be depleted or reduced over time: one or more disposable batteries, an electric charge stored in a rechargeable battery, and/or one or more lights (e.g., light bulbs or light-emitting diodes (“LEDs”)). In some embodiments, an electric deodorizer may have one or more consumable resources that may be depleted or reduced over time: a scent element and/or a filtering or odor-capturing element. In any embodiment, including any of those described above, another consumable resource—such as a battery—may or may not be utilized by the domestic appliance, depending on the embodiment (e.g., what type of power source the domestic appliance uses).

In some embodiments, a domestic appliance may include a device, apparatus, or other mechanism which provides information about a consumable resource that is associated with the appliance (e.g., a consumable resource that is contained within or supported by a container or holder of the appliance). For example, the domestic appliance may enable at least a general or specific assessment, determination, estimate, calculation, and/or measurement of the level or amount remaining of a particular consumable resource and/or the level or amount used of a particular consumable resource and/or one or more other features or characteristics of the consumable resource (e.g., the type of consumable resource, such as soap or lotion or hand sanitizer, the density of the consumable resource, and/or any other feature or characteristic of the consumable resource). In some embodiments, the information provided by the appliance about the consumable resource is measured and/or calculated internally or exclusively by the appliance and/or independently of the user, without requiring the user to first input or communicate information that is later provided by the appliance and/or without requiring a calculation by the appliance based upon information that is initially inputted or communicated by the user to the appliance. In some embodiments, a computer processor and/or algorithm of the appliance and/or of another electronic device is or are configured to automatically detect or predict depletion or near depletion of a consumable resource without requiring input from a user.

For example, in some embodiments, there is a mass sensor and/or a volume sensor for measuring and/or calculating the mass and/or volume of a consumable resource. In some embodiments, a mass sensor can comprise a pressure plate positioned within, outside, or near a reservoir, container, or holder configured to receive and/or retain a consumable resource. The pressure plate can be configured to produce an electrical signal that changes in relation to an amount of mass in, on, or held by the reservoir, container, or holder. In some embodiments, a mass sensor can comprise a gravity-assisted scale or other similar apparatus that is configured to measure weight, pressure, force per area, etc., which may be included at the bottom of a reservoir, container, or receptacle in order to measure a weight of the contents contained in the reservoir, container, or receptacle. Such a gravity-assisted scale may be of particular benefit in, for example, a soap dispenser or a trash can, either of which typically includes a reservoir, container, or receptacle that holds contents that are conducive to being weighed (e.g., if the contents are in a vertical configuration). For example, a soap dispenser may have a reservoir designed to hold a certain type of soap with a known approximate density or approximate weight per approximate volume. A gravity-assisted scale may indicate a weight of any soap remaining, which may then be used with the known density/weight information to determine an approximate volume (e.g., a number of milliliters) remaining. In some examples, a trash can may include a receptacle that has a predetermined or known approximate maximum weight capacity, and a gravity-assisted scale may be used to indicate the approximate weight of waste in the receptacle to determine how much more waste may be added (e.g., the remaining amount of the consumable capacity resource of the trash can).

In some embodiments, one or more sensors, such as a light-based sensor, configured to detect presence of an object, may be included in a domestic appliance, such as to detect presence of internal contents at various vertical positions within a reservoir, container, or receptacle. For example, a trash can receptacle may include object-detection sensors on the inner surface of the receptacle at levels or heights corresponding to one or more generally equal sub-volumes of the receptacle, (such as about: 25%, 50%, 75%, and/or 100% percentiles, or any other desired increment(s)). When objects (e.g., waste) in the receptacle are detected by the sensors at each respective height, the trash can may record or report the measurement corresponding to the respective height. Thus, if waste is detected at a particular height, the trash can may determine that it has reached a capacity associated with the particular height.

In some soap dispenser examples, the same or similar object-detection sensors may be included to detect presence of the liquid soap at various levels or heights of a reservoir. When an object (e.g., a liquid) in the reservoir is detected by the sensors at each respective height, the soap dispenser may record or report the measurement corresponding to the respective height. Thus, if liquid is detected at a particular height, the soap dispenser may determine that it has still has an amount of soap remaining associated with the particular height. In some embodiments, one or more sensors may be positioned on or affixed to the inside surface of the reservoir at certain fixed positions. In some embodiments, a sensor may be configured to float on the surface of a liquid and detect identified markers (such as notches or protrusions) on the inside surface of the reservoir at certain fixed positions.

In some embodiments, certain domestic appliances may be preconfigured with, for example, a known quantity, amount, or capacity associated per refill or per replacement item or cartridge, and/or a known quantity or amount per use of the refill (e.g., per dispense for a soap dispenser). Thus, the domestic appliance (or the domestic appliance communication system) may be able to determine a quantity used (and/or quantity remaining) based on the known total amount of capacity, the amount dispensed per use, and a measured or observed number of uses. In some embodiments, a flow rate over time may also be known, measured, or observed in order to determine an amount used. Other variations to determine an amount or capacity used and/or amount or capacity remaining may also be possible.

Depending on the embodiment, remaining amounts may be measured or reported in either absolute terms (e.g., 100 ml of soap estimated to remain, 5 lbs of trash can capacity estimated to remain, 10 hours of LED life estimated to remain, 1 hour of battery life estimated to remain, etc.) or relative or percentage terms (e.g., 10% of soap estimated to remain, 50% of trash can capacity estimated to remain, 1% of LED life estimated to remain, 20% of battery life estimated to remain, etc.). Measurements may be made with any degree of granularity from 1 to 100. Some embodiments may measure one degree of granularity (e.g., every 1%) but only report or provide status information for another degree of granularity (e.g., every 5%). Any variation may be implemented.

Domestic appliances as generally described herein may further include logic or circuitry to enable network connectivity either directly (such as over a cellular or broadband data network) or indirectly (such as over a home or local Wi-Fi network) with a remote system operating on a different network domain. Such network connectivity may be used by a domestic appliance to, for example, transmit, to a remote system (such as domestic appliance communication system) status information associated with consumable resources of the domestic appliance, and/or to receive, from the remote system, data such as an updated dispenser amount (e.g., for a soap dispenser), a brightness level (e.g., for an LED or other light fixture) and so forth.

In some embodiments, a domestic appliance as described herein may be configured to periodically measure its consumable resources and/or periodically transmit status information to a remote system, such as the domestic appliance communication system. For example, the domestic appliance may measure and transmit consumption information monthly, weekly, daily, several times a day, hourly, etc. The time period may depend on the nature of the particular consumable resource, how often the resource may need to be refilled or replaced, and/or the location of the domestic appliance. For example, a main bathroom that tends to be used frequently may be configured to measure and/or report status information hourly, whereas a guest bathroom that tends to be used less frequently may be configured to measure and/or report status information daily or weekly. Similarly, a vanity mirror that uses LEDs that may not need be replaced for months or years may be configured to measure and report LED remaining life information monthly. The measuring and transmitting may be performed on the same periodic basis or on a different periodic basis depending on the particular embodiment.

In some embodiments, any domestic appliance may include an opaque resource container or reservoir (e.g., a metal container or a non-transparent plastic container) that obscures an external, naked-eye view of the consumable resource contained within it, and/or any domestic appliance may include a consumable resource for which a remaining life or capacity cannot be readily determined by visual inspection (e.g., an electric charge in a battery), which may be aesthetically preferable, but which may make it especially difficult to monitor internal consumable contents or status. In these circumstances, it may be especially useful to provide a remote or external display or monitor to enable the consumer to monitor or modify an amount associated with each use of the consumable resource, such as an amount of soap dispensed per dispense action (e.g. pump) of a soap dispenser.

Various domestic appliances and domestic appliance communications systems are described below to illustrate various examples that may be employed to achieve one or more desired improvements. These examples are only illustrative and not intended in any way to restrict the general embodiments presented and the various aspects and features of these embodiments. Furthermore, the phraseology and terminology used herein is for the purpose of description and should not be regarded as limiting. No features, structure, or step disclosed herein is essential or indispensable.

### Example System Architecture

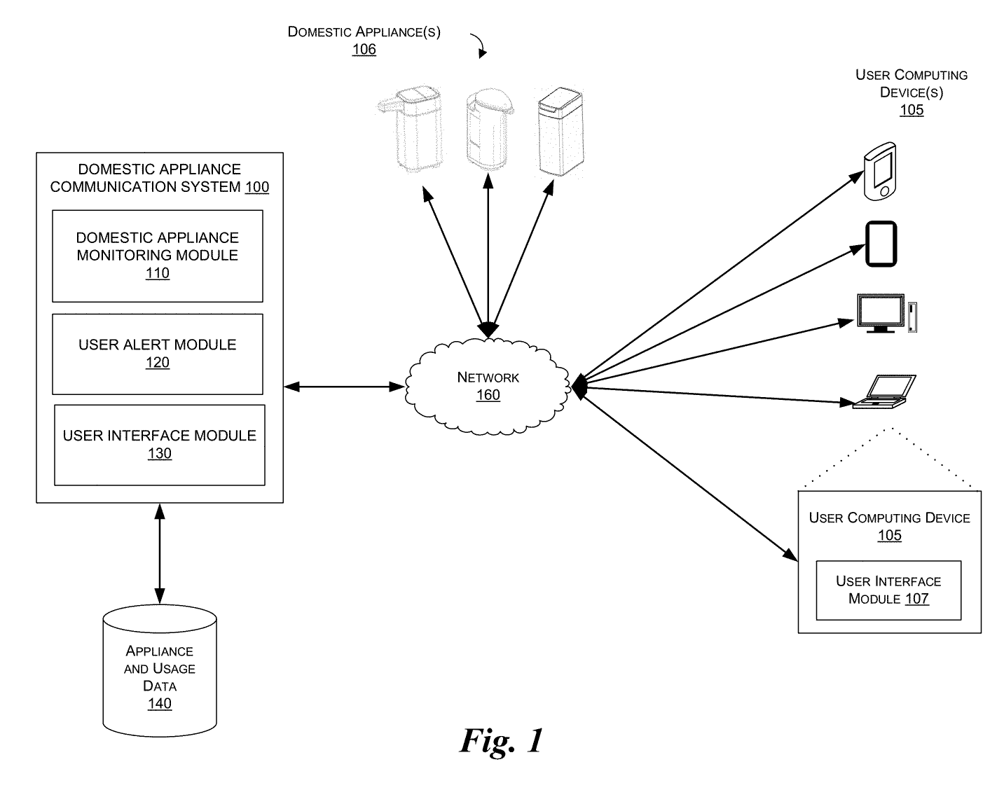

FIG. 1 is a general architecture diagram schematically illustrating an example of a domestic appliance communication system 100 that performs and provides the domestic appliance communications services and processes described herein. The domestic appliance communication system 100 can include any system capable of performing the processes described herein. For example, in the illustrated embodiment of FIG. 1, the domestic appliance communication system 100 communicates with one or more user computing devices 105 and one or more domestic appliances 106 over a network 160. In FIG. 1, the domestic appliance communication system 100 includes several components such as a domestic appliance monitoring module 110, a user alert module 120, and a user interface module 130. These components may also include further components that may not be depicted in FIG. 1. For example, domestic appliance communication system 100 can also include one or more servers, e.g., a web server, configured to receive status data from domestic appliances 106 and receive and respond to requests from the user computing devices 105.

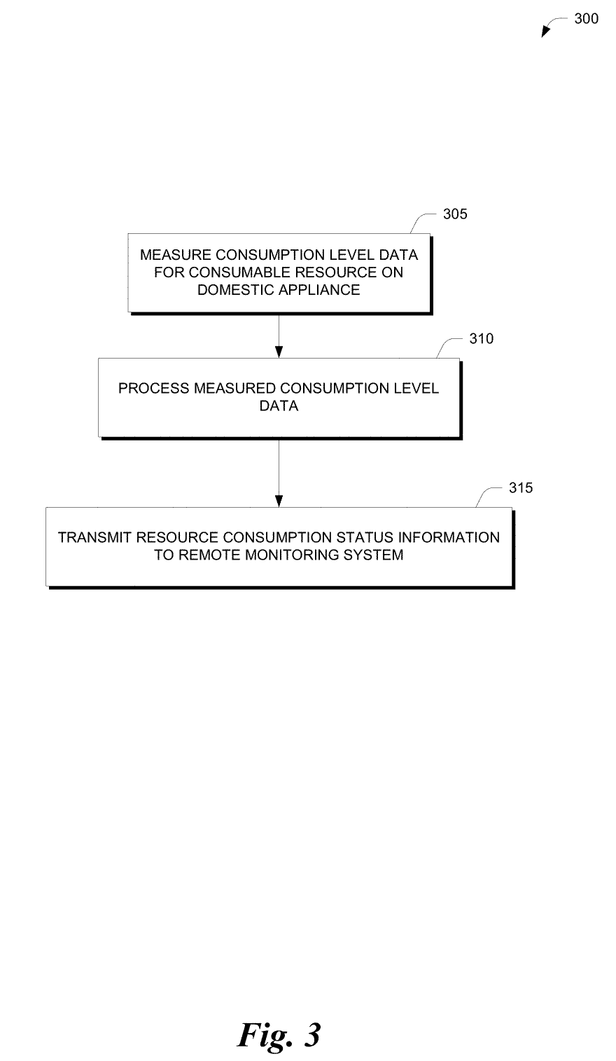

The domestic appliance monitoring module 110 may be configured to, for example, receive and process status information and other data from domestic appliances 106. In particular, the domestic appliance monitoring module 110 may be configured to execute various processes, such as the process 300 illustrated and described in more detail with reference to FIG. 3 herein. The domestic appliance monitoring module 110 may also be configured to store received status information and other data in appliance and usage data store 140 for later access, retrieval, and analysis as described further herein.

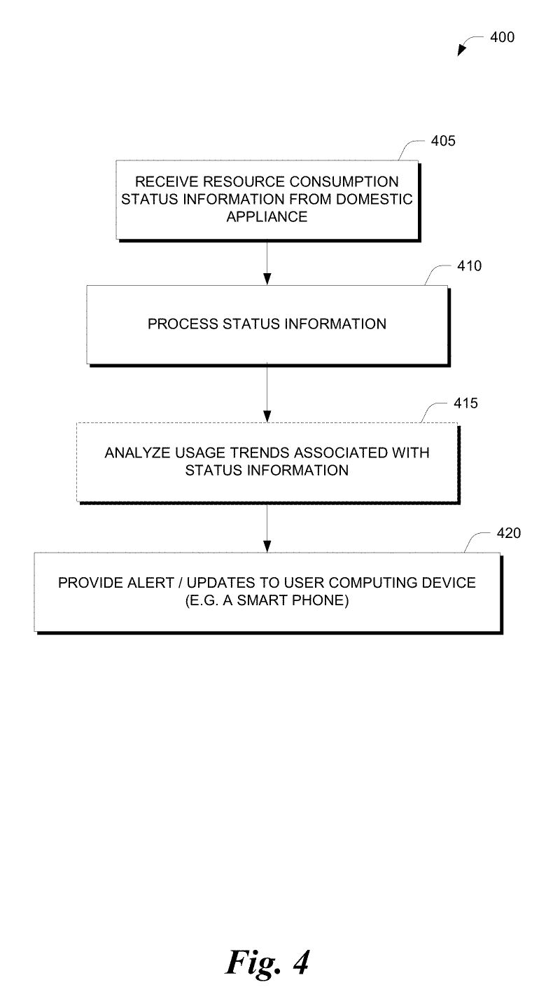

The user alert module 120 may be configured to, for example, provide alerts and other information, such as domestic appliance usage data, to user computing devices 105. In particular, the user alert module 120 may be configured to execute various processes, such as the process 400 illustrated and described in more detail with reference to FIG. 4 herein. For example, user alert module 120 may be configured to generate and/or send an alert or notification to a user computing device 105 when levels of a consumable resource on a domestic appliance are running low and/or projected to run out. User alert module 120 may also send an alert if no data has been received from a particular domestic appliance for some time (e.g., which may indicate that the user might need to check battery, send in the domestic appliance for repair, replace a malfunctioning sensor, etc.). Alerts may be delivered, for example, via any traditional communication (e.g., paper mail service) and/or via any electronic format or medium, such as electronic mail, text message (Short Message Service (SMS) or Multimedia Message Service (MMS)), instant messaging, in-application message, and so forth.

Alerts may be sent to user computing device 105 based on a variety of information and in response to different triggering events. In some embodiments the user alert module 150 may be configured to automatically convey or “push” updates to user computing device 105 as status information is received from domestic appliances 106. For example, when the domestic appliance communication system 100 receives an indication from a particular domestic appliance that a consumable resource is running low (e.g., at or below a pre-determined threshold amount that can be set by a consumer in some embodiments), the user alert module 150 may transmit a corresponding alert to the user computing device 105. In some embodiments, the user alert module 150 may add a refill or resource replacement item to a shopping list on behalf of the user, with or without notifying the user. The shopping list, for example, may then be provided or presented on demand by the user via user computing device 105, such as when the user is on his/her next shopping trip.

Alerts may also be sent or triggered, in whole or in part, in response to data received from user computing device 105, such as GPS coordinates or other location data. For example, GPS coordinates or location data may indicate that the user computing device 105 is at or near a location such as a supermarket or domestic goods retailer where a refill or replacement may be purchased. Responsive to making such a determination, user alert module 120 may send an alert, notification, or reminder message to the user computing device 105 to purchase the refill or replacement item from the nearby supermarket or retailer. In some embodiments, alerts may also include one or more coupons or targeted advertisements in relation to the needed refill or replacement item. In some embodiments, an alert may provide a purchase link which the user may select to purchase a household item such as a refill or replacement, for example from an electronic marketplace or retailer.

The user interface module 130 may be configured to construct or provide user interfaces of various types. One or more user interfaces may, in some embodiments, be provided in conjunction with alerts and other information provided by user alert module 120. In some embodiments, user interface module 130 constructs or provides web pages to be displayed in a web browser or computer/mobile application. The web pages may, in some embodiments, be specific to a type of device, such as a mobile device or a desktop web browser, to maximize usability for the particular device. In some embodiments, user interface module 130 may also interact with a client-side application, such as a mobile phone application (an “app”) or a standalone desktop application (that may be, for example, installed on a user computing device 105), and provide data to the application as necessary to display domestic appliance status information. In some embodiments, the domestic appliance communication system 100 may be a web-based system that may be accessed by users using an ordinary web browser.

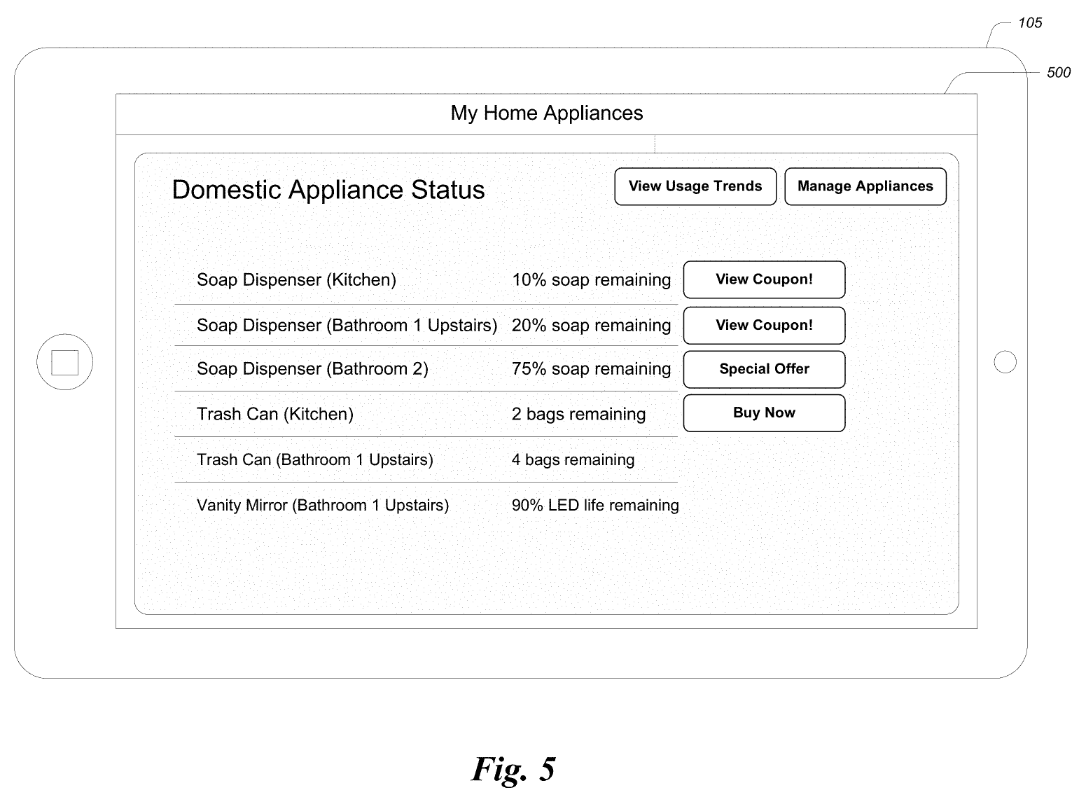

Also shown in FIG. 1, a sample user computing device 105 may include a user interface (“UI”) module 107 which may be configured to execute some or all of the processes described herein. This may, for example, enable the user computing device 105 to present alerts and other data received from the domestic appliance communication system. The user interface module 107 may be configured to, for example, generate one or more user interfaces, such as the user interfaces described herein (e.g., FIGS. 5-24), to provide domestic appliance status information and management options to the user of the device. In some embodiments, some or all of the user interfaces and/or UI elements may be generated either by the domestic appliance communication system 100 and provided to the user computing device 105, or they may be generated on the user computing device 105 via the user interface module 107, or in some combination thereof.

User computing device 105 may be an end-user computing device that comprises one or more processors able to execute programmatic instructions and may comprise software and/or hardware that implement the user interface module 107. Examples of such a computing device 105 are a desktop computer workstation, a smart phone such as an Apple iPhone or an Android phone, a computer laptop, a tablet PC such as an iPad, Kindle, or Android tablet, a video game console, or any other device of a similar nature. In some embodiments, the user computing device 105 may comprise a touch screen that allows a user to communicate input to the device using their finger(s) or a stylus on a display screen. User computing device 105 may comprise storage systems such as a hard drive or memory, or comprise any other non-transitory data storage medium. The storage systems may be configured to store executable instructions that may be executed by one or more processors to perform computerized operations on the user computing device, accept data input from a user (e.g. on the touch screen), and/or provide output to a user using the display.

Also shown in FIG. 1, the domestic appliance communication system 100 may include and/or have access to one or more data stores or data sources including, for example, an appliance and usage data store 140. The usage data store 140 may include or store data for the domestic appliance communication system 100, such as status information or other data received from domestic appliances 106. For example, status information such as consumption and usage data for one or more domestic appliances 106 associated with a household or individual may be collected, stored, aggregated, and analyzed by the domestic appliance communication system 100 over time.

Domestic appliance communication system 100 may use the stored and/or otherwise analyzed usage data to identify or determine usage patterns, trends, preferences and the like that may be associated with particular domestic appliances associated with the household or individual. Such usage patterns may then be used by the domestic appliance communication system 100 to predict when a particular domestic appliance may need a refill or replacement of a consumable resource. For example, a soap dispenser located in a kitchen may be used often on a regular basis, which may indicate a need for frequent refills on a predictable periodic basis.

Appliance and usage data store 140 may be of a particular benefit if, for example, a particular domestic appliance stops sending status information to the domestic appliance communication system 100 (e.g., if the domestic appliance experiences a technical failure, such as loss of power supply, loss of network connectivity, or the like). If status information has not been received from a particular domestic appliance for some defined or threshold period of time, the domestic appliance communication system 100 may nonetheless be able to predict that the domestic appliance may require replacement of a consumable by using data stored in usage data store 140. For example, domestic appliance communication system 100 may determine or predict that for a particular domestic appliance a consumable resource needs to be refilled or replaced once every 10 days. Based on this prediction, the domestic appliance communication system 100 may provide an alert on a periodic basis to the user that a refill may be needed regardless of whether actual or recent status information has been received from the domestic appliance. The domestic appliance communication system 100 may also be able to notify a user that the particular household appliance might be experiencing a technical failure and prompt the user to investigate and/or send the household appliance in for repair or replacement.

Predicting usage patterns may also be of benefit to the household or individual for purposes of planning a shopping trip. For example, a particular domestic appliance may not yet be running low on a consumable resource, but the domestic appliance communication system 100 may be able to predict when the domestic appliance will be low, based on past usage data patterns. The domestic appliance communication system 100 may then provide this information to the user, who may decide to buy a refill or replacement of the consumable resource on a future shopping trip (for example, the user may wish to have a refill readily available if the consumable resource is predicted to run out before the user's next planned shopping trip).

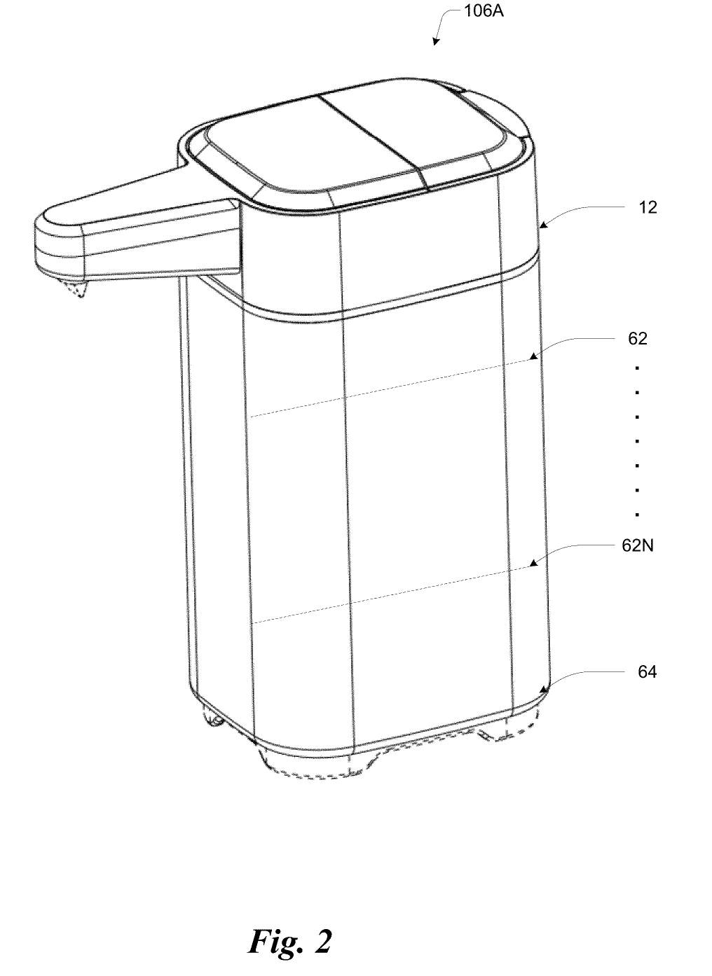

FIG. 2 is a schematic diagram illustrating example domestic appliance, an electric soap dispenser 106A, that can include various features and embodiments of the features disclosed herein. The present features are disclosed in the context of an electric soap dispenser 106A because they have particular utility in this context. However, many of the features disclosed herein can be used in many other diverse contexts and environments of use. For example, many or all of the features disclosed herein can be used in other types of domestic appliances, dispensers, battery-powered devices, or even any other electric device. For example, one or more of the features disclosed herein regarding sensor actuation can be used in any type of device (for example, a trash can) that may include one or more sensors that detect the presence of an object or other parameters or characteristics. Those of ordinary skill in the art will recognize, from the description set forth below, many of the other environments of use in which the present features can be used, although those environments are not described herein. Some examples electric soap dispensers that may be configured to include the improvements described in the present disclosure are described and/or illustrated in U.S. Pat. No. 8,096,445 (“the '445 Patent”), which is hereby incorporated by reference in its entirety.

The electric soap dispenser 106A illustrated in FIG. 2 may be configured to measure consumption of a consumable resource, such as liquid soap, in any number of ways, which may be implemented separately or in any combination. FIG. 2 illustrates a couple of optional alternatives that may be implemented separately or in combination; however, any suitable configuration or apparatus may be utilized such that taking a general, reasonable, or estimated measurement of how much of a consumable resource has been used, or how much is or may be remaining, is enabled. For example, although not expressly described or illustrated in detail herein, those skilled in the art will recognize that a mechanism to measure or monitor power consumption of a battery, and/or estimate a remaining battery charge, may be implemented in accordance with the embodiments described herein.

In the embodiment of a domestic appliance shown in FIG. 2, electric soap dispenser 106A includes at least a housing 12 which can take any shape. Although not illustrated in FIG. 2, as described in the '445 Patent, the electric soap dispenser 106A may include inside the housing 12 at least a reservoir 16, configured to contain a volume of liquid soap; and an electronic control unit (“ECU”) 46 which can include one or a plurality of circuit boards providing a hard wired feedback control circuits, a processor and memory devices for storing and performing control routines, or any other type of controller. In an exemplary but non-limiting embodiment, the ECU 46 can include an H-bridge transistor/MOSFET hardware configuration which allows for bidirectional drive of an electric motor, and a microcontroller such as Model No. PIC16F685 commercially available from the Microchip Technology Inc., and/or other devices.

The ECU 46 may be connected to one or more sensor devices 62 through 62N, which are illustrated in FIG. 2. Each sensor device may be implemented in order to detect whether liquid soap is present at a given level in the reservoir 16. Any number of desired sensors may be implemented, corresponding to different levels, depending upon the embodiment. Some embodiments implement a plurality of sensors, such as at least three sensors 62, such as one corresponding to a generally 25^{th} percentile, one corresponding to a generally 50^{th} percentile, and one corresponding to a 75^{th} generally percentile, for example. For ease of explanation, each of the one or more sensors 62 through 62N are referred to below as sensor device 62, or simply sensor 62.

In some embodiments, the sensor device 62 can include a “trip light” or “interrupt” type sensor. For example, the sensor 62 can include a light emitting portion and a light receiving portion. A beam of light can be emitted from the light emitting portion and received by the light receiving portion. The sensor 62 can be configured to emit a trigger signal when the light beam is blocked. For example, if the sensor 62 is activated, and the light emitting portion is activated, but the light receiving portion does not receive the light emitted from the light emitting portion, then the sensor 62 can emit a trigger signal. This trigger signal can be used for indicating that liquid soap is present at the predefined level in the reservoir 16 in accordance with measuring the remaining amount of liquid soap. This type of sensor can provide further advantages.

For example, because the sensor 62 is merely an interrupt-type sensor, it is only triggered when an object is disposed in the path of the beam of light. Thus, the sensor 62 is not triggered by movement of a body in the vicinity of the beam 44. Rather, the sensor 62 is triggered only if the light beam is interrupted. In addition, for example, the sensor 62 only requires enough power to generate a low power beam of light, which may or may not be visible to the human eye, and to power the light receiving portion. These types of sensors require far less power than infrared or motion-type sensors. Additionally, the sensor 62 can be operated in a pulsating mode. For example, the light emitting portion can be powered on and off in a cycle such as, for example, but without limitation, for short bursts lasting for any desired period of time (e.g., 0.01 second, 0.1 second, 1 second) at any desired frequency (e.g., once per half second, once per second, once per ten seconds). These different time characteristics can be referred to as an activation period or frequency, which corresponds to the periodic activation of the sensor 62. Thus, an activation frequency of four times per second would be equivalent to an activation period of once per quarter second.

The other aspect of this characteristic can be referred to as an activation duration. Thus, if the sensor 62 is activated for 50 microseconds, 50 microseconds is the activation duration time period. As such, this type of cycling can greatly reduce the power demand for powering the sensor 62. In operation, such cycling does not produce unacceptable results because as long as the object in the path of the light beam remains long enough for a detection signal to be generated, the sensor 62 will be triggered.

The ECU 46 may be configured to activate each sensor 62 through 62N on a periodic basis as part of a routine to measure or estimate the remaining amount of liquid soap in the reservoir 16. If a sensor 62 is triggered, the ECU 46 may determine that liquid soap is present at the corresponding level for that sensor. For example, in some embodiments, the electric soap dispenser can include a plurality of sensors, such as three sensors 62A, 62B, and 62C, that are positioned at generally equal increments, such as the quarter increments as described above. Then, the ECU 46 may receive a signal or reading from one or more of sensor 62A, 62B, and/or 62C and, based on which sensor (if any) is triggered, determine whether liquid soap is likely present at each corresponding increment. For example, if sensor 62A at the 25^{th} percentile and sensor 62B at the 50^{th} percentile are triggered, but sensor 62C at the 75^{th} percentile is not triggered, the ECU 46 may interpret these triggers to indicate that the volume of liquid remaining is somewhere between 50 and 75 percent of the capacity of the reservoir 16. One can see that the more sensors 62 implemented in such a design, the higher degree of resolution, granularity, and/or accuracy may be obtained.

In some embodiments, the electric soap dispenser 106A may include a scale 64 coupled to the bottom of the reservoir 16 and configured to weigh the volume of liquid soap contained in the reservoir 16. The scale 64 may be positioned inside the reservoir 16, for example as a mesh-based array or membrane of a number of weight sensors to measure a force per area which can be calibrated to reasonably measure the weight of a liquid volume contained in the reservoir 16. In some embodiments, the scale 64 may be positioned outside the reservoir 16 and be calibrated to measure the weight of the reservoir 16 and its contents; in this way the weight of any contents may then be calculated or determined by subtracting a known or predetermined weight of the reservoir 16 from the total measured weight. As described elsewhere in the present disclosure, the weight of the liquid soap may be used with other known characteristics of the liquid (e.g., a density or weight per volume) to determine or estimate the quantity of liquid remaining in the reservoir 16.

Electric soap dispenser 106A may further include a network interface chip (not shown in FIG. 2) in communication with the ECU 46 and configured to enable transmission and receipt of network communications, either over a wired or wireless network, in accordance with the features described herein.

Electric soap dispenser 106A can also include a power supply. The power supply can be a battery or can include electronics for accepting AC or DC power. In certain embodiments, the ECU 46 can read the voltage of the power source. In some embodiments, the power source is a rechargeable battery or a plurality of disposable batteries. In an exemplary but non-limiting embodiment, the power source comprises four AA batteries. Over time, the electrical output (e.g., voltage and/or current) of such batteries can decrease. Thus, by detecting the electrical output of the power source, ECU 46 can monitor or measure energy consumption over time. Other types of detectors can also be used.

### Example Methods Performed by a Domestic Appliance Communication System

FIGS. 3 and 4 are logical flow diagrams for various embodiments of monitoring domestic appliance consumption and providing alerts to users. In some implementations, the routines are performed by embodiments of domestic appliance communications system 100 described with reference to FIG. 1 or by one of its components, such as the domestic appliance monitoring module 100, the user alert module 120, and/or the user interface module 130, and/or by embodiments of the domestic appliance 106 described with reference to FIG. 2. The example scenarios are intended to illustrate, but not to limit, various aspects of the domestic appliance communications system 100 and/or domestic appliance 106. In some embodiments, the routines can be dynamic, with some procedures omitted and others added. In some embodiments, multiple instances of the routines may be occurring concurrently, for different domestic appliances and user computing devices.

FIG. 3 is a logical flow diagram of an embodiment of a process 300 for monitoring the status of a domestic appliance, involving a domestic appliance 106. For ease of illustration the process 300 is described as being performed by electric soap dispenser 106A; however, the process 300 may be performed by any domestic appliance 106 configured to measure or otherwise monitor consumption levels of one or more consumable resources (e.g., a dispensed material, energy and/or space, etc.).

At block 305, the electric soap dispenser 106A measures consumption level data for a consumable resource on the electric soap dispenser. For example, the consumable resource may be a liquid soap contained in the reservoir 16, or a battery acting as a power supply. The electric soap dispenser 106A may be configured to measure the consumption level data on a periodic basis such as hourly, a number of times per day, and so on. To conserve energy, or depending on the frequency of use of the dispenser, the electric soap dispenser 106A may measure the consumption level data less frequently.

Measuring the consumption level data may be performed, for example, by activating the sensors 62A . . . 62N and determining whether and/or which of the sensors 62A . . . 62N are triggered in response. Alternatively, in embodiments implementing scale 64, the scale 64 may be activated and associated force per area calculations or measurements may be obtained.

At block 310, the domestic appliance 106 processes the measured consumption level data, for example to determine or estimate a used or remaining portion of the consumable resource. For example, as discussed above, whether one or more of the sensors 62A . . . 62N are triggered may be processed by the ECU 46 to determine or estimate a remaining level of the contents of the reservoir 16. Or, in another non-limiting example, the measured data received from scale 64 may be processed to determine or estimate a remaining amount of the contents of the reservoir 16 based in part on other known characteristics (e.g., density of the liquid, weight of the reservoir 16, etc.).

At block 315, the electric soap dispenser 106A transmits the resource consumption data to a remote monitoring system, such as the domestic appliance communications system 100. The data may be transmitted by the ECU 46 via an on-board network interface ship or logic circuitry. In some embodiments, the electric soap dispenser 106A may be pre-configured with protocols and instructions used to communicate with a particular remote monitoring system over a cellular network. In some embodiments, the electric soap dispenser 106A may be configured to communicate with a remote monitoring system over a broadband network, connecting to a home or local network as a bridge to the remote monitoring system. In some embodiments, an end user may be able to configure the electric soap dispenser 106A to communicate with a desired remote monitoring system when the electric soap dispenser 106A is initially setup.

The process 300 at blocks 305, 310, and 315 may be performed automatically by the electric soap dispenser 106A on a periodic basis. The time period may be preconfigured, it may be user-defined, or it may be adapted over time by the electric soap dispenser 106A itself based on the frequency of use of the device. For example, the electric soap dispenser 106A may further be configured to maintain an internal counter corresponding to the number of dispenses activated, and based on the internal counter reaching a certain number or repeating interval (e.g., every 10, 20, 50, etc. dispenses), trigger the process 300 to measure the consumption data as described above. In some embodiments, each dispense amount may be a known or measurable quantity, which the electric soap dispenser 106A may use in combination with the internal counter to measure or approximate the total amount dispensed over time.

FIG. 4 is a logical flow diagram of an embodiment of a process 400 for providing domestic appliance status information remotely to a user computing device, involving a domestic appliance communication system. The process 400 may be performed, for example, by the domestic appliance communication system 100 of FIG. 1.

At block 405, domestic appliance communication system 100 receives, from a domestic appliance such as the electric soap dispenser 106A of FIG. 2, resource consumption status information. The received resource consumption status information may include information identifying the domestic appliance, the type of consumable resource (or resources, if multiple) measured, and measurement data which may be raw or processed measurement data. The measurement data may indicate an amount or estimated amount used or remaining of each respective consumable resource (in either relative or absolute terms). For example, the domestic appliance communication system 100 may receive, from an electric soap dispenser 106A, status information indicating that an amount such as 100 ml remains in the reservoir of the dispenser, and/or status information indicating that a battery (or batteries) has (or have) approximately 50% remaining life before needing replacement or recharging.

At block 410, domestic appliance communication system 100 processes the received status information. For example, domestic appliance communication system 100 may use domestic appliance identifying information included with the received status information to look up the domestic appliance in a table stored on usage data store 140.

In some embodiments, domestic appliance communication system 100 may be configured to process raw or incomplete data received from the domestic appliance. For example, the domestic appliance communication system 100 may have access to additional product information (such as a total or maximum capacity of a reservoir on an particular soap dispenser, or a maximum weight allowance for a waste receptacle on a particular trash can) that may be used to further process status information. For example, a soap dispenser may only transmit an amount of liquid soap remaining in absolute terms (e.g., 100 ml), which the domestic appliance communication system 100 may then use in combination with an accessed or looked-up total capacity (e.g., 1000 ml) to determine additional status information such as an approximate percentage remaining (e.g., 10%).

At block 415, domestic appliance communication system 100 may optionally analyze usage trends associated with the status information. For example, usage data 140 may be utilized to store and retrieve status information for a plurality of domestic appliances. As these data points are received and collected over time, the domestic appliance communication system 100 may analyze the data to determine usage trends, generate predictions for when certain consumable resources are projected to be depleted and require replacement or replenishment, and so on. These analyzed data trends and predictions may be used to inform the alerts sent to the consumer, as well as be presented to the consumer via one or more user interfaces.

At block 420, domestic appliance communication system 100 provides an alert and/or update to a computing device associated with the consumer to whom the domestic appliance belongs. Domestic appliance communication system 100 may use domestic appliance identifying information to look up or identify, using the usage data 140, a consumer associated with the device to whom an alert should be sent. The associated consumer information may also include associated delivery settings for the alert, such as a phone number, an email address, or other communication means (such as via an in-application alert that is to be presented via an application installed on the consumer's computing device). The alert may be provided to the consumer immediately or at any time once it has been received and processed by the system.

In some embodiments, domestic appliance communication system 100 provides the status information in response to a request received from the consumer. Such a request may be received, for example, when the consumer signs in to an account or app to view status information associated with his/her domestic appliances.

As mentioned elsewhere in this disclosure, domestic appliance communication system 100 may also provide additional information and options for the consumer, including coupons, advertisements, and/or user interfaces by which the consumer can manage his/her domestic appliances remotely.

### Example User Interfaces

FIGS. 5-24 illustrate various sample domestic appliance management user interfaces that may be generated by or used with the DAC system 100, providing various user interface controls to enable functionality as described in this disclosure. The user interfaces of FIGS. 5-24 are illustrated in the context of an application executing on a mobile computing device. However, in various embodiments, any of the user interfaces shown in FIGS. 5-24 may be presented as a web page, as a mobile application, as a stand-alone application, or by other communication means. In some embodiments, analogous interfaces may be presented using audio or other forms of communication. In some embodiments, the interfaces shown in FIGS. 5-24 are configured to be interactive and respond to various user interactions. Such user interactions may include clicks with a mouse, typing with a keyboard, touches and/or gestures on or in proximity to a touch screen, voice commands, and/or the like.

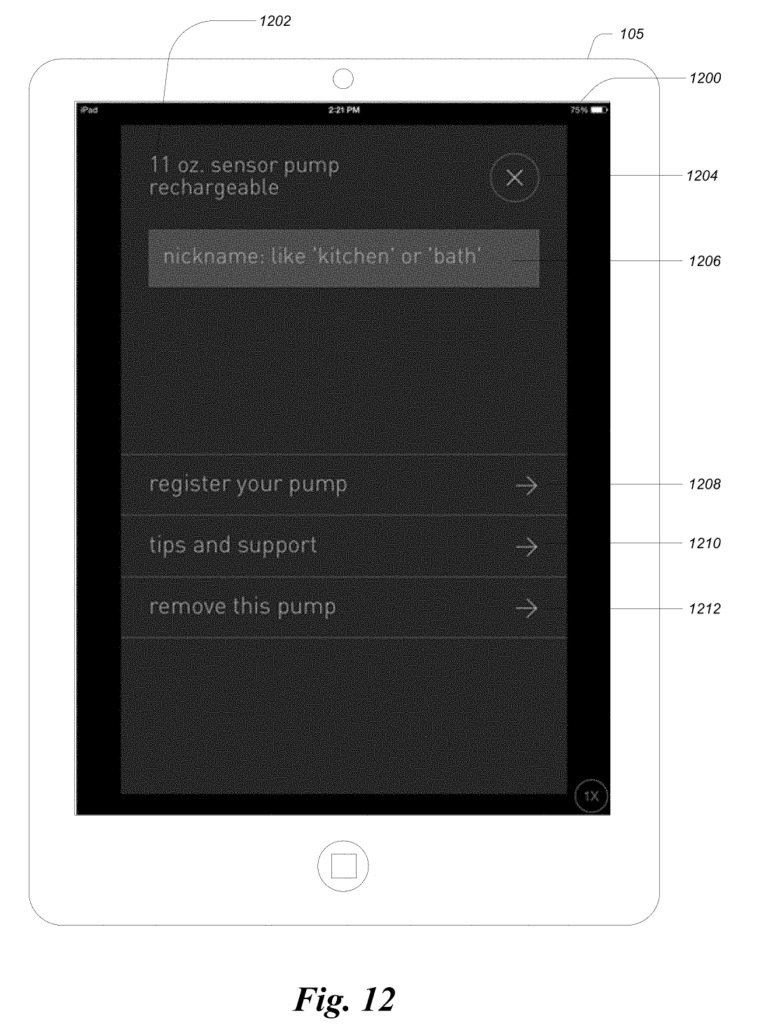

In some embodiments, as shown, the user information system for domestic appliances can be a domestic appliance management application (“app”) that enables product shopping, product registration, conveyance of product information, and/or ordering of product disposables or consumables. For example, FIG. 5 illustrates a sample “domestic appliance status” user interface 500 that may be generated by or used with the DAC system 100, User interface 500 presents status information and various associated options for a user with respect to one or more domestic appliances associated with the user and/or the user's household. The one or more domestic appliances may be added to or associated with an account of the user and/or the user's household, for example by various of the user interfaces described in further detail below. For each domestic appliance the user interface 500 can include a corresponding description (which may be edited or configured by the user, for example as illustrated and described with reference to FIG. 12); status information about one or more consumable resources; an optional link to purchase a refill or replacement from a retailer or from the manufacturer; an option to view coupons, special offers, or advertisements; and in some embodiments an option to manage use and other characteristics for the domestic appliance, such as an amount of soap to be dispensed by a soap dispenser. User interface 500 may also optionally present usage trend data and/or an option to view usage data detail, which may be presented within the same user interface or in a separate user interface.

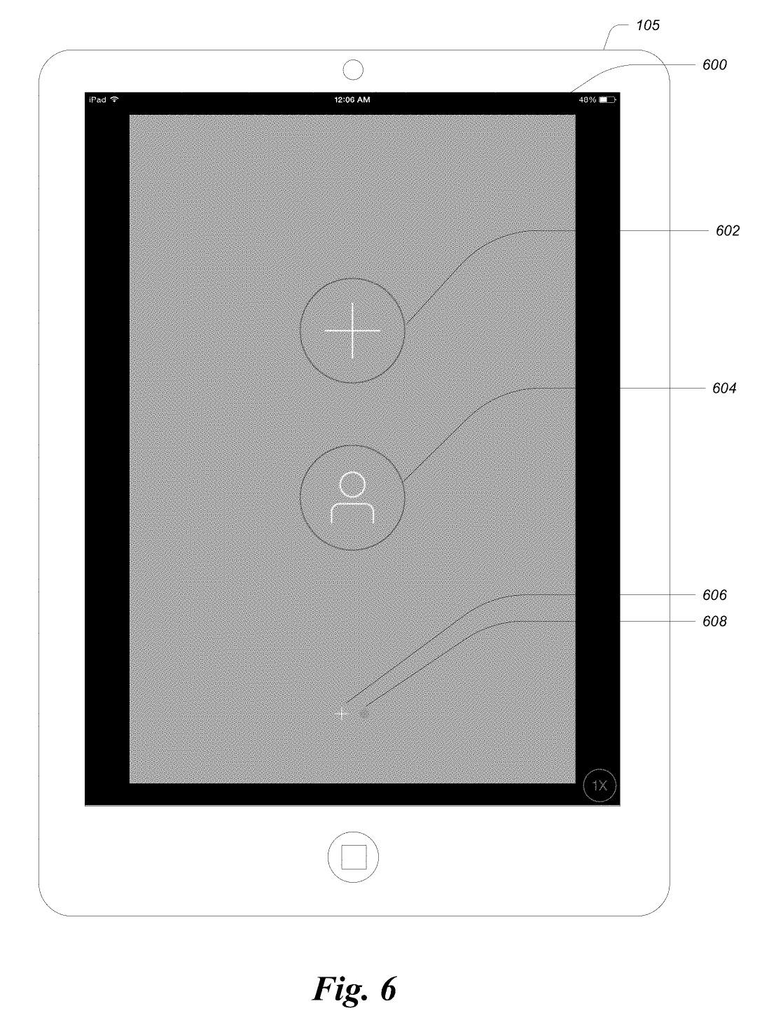

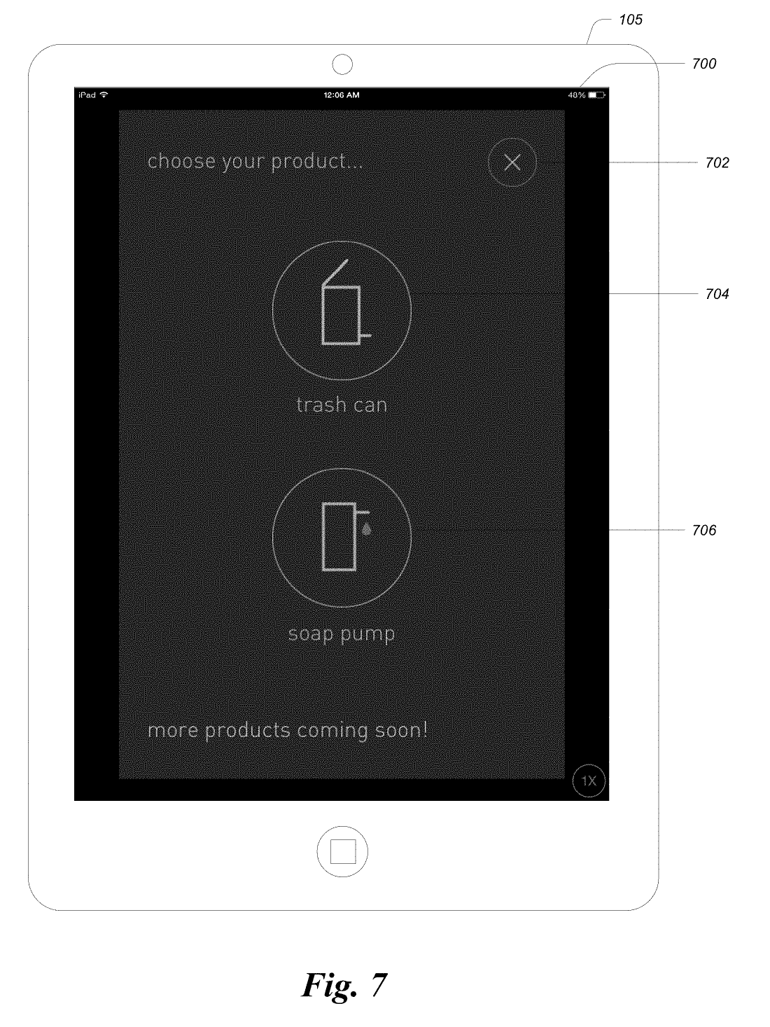

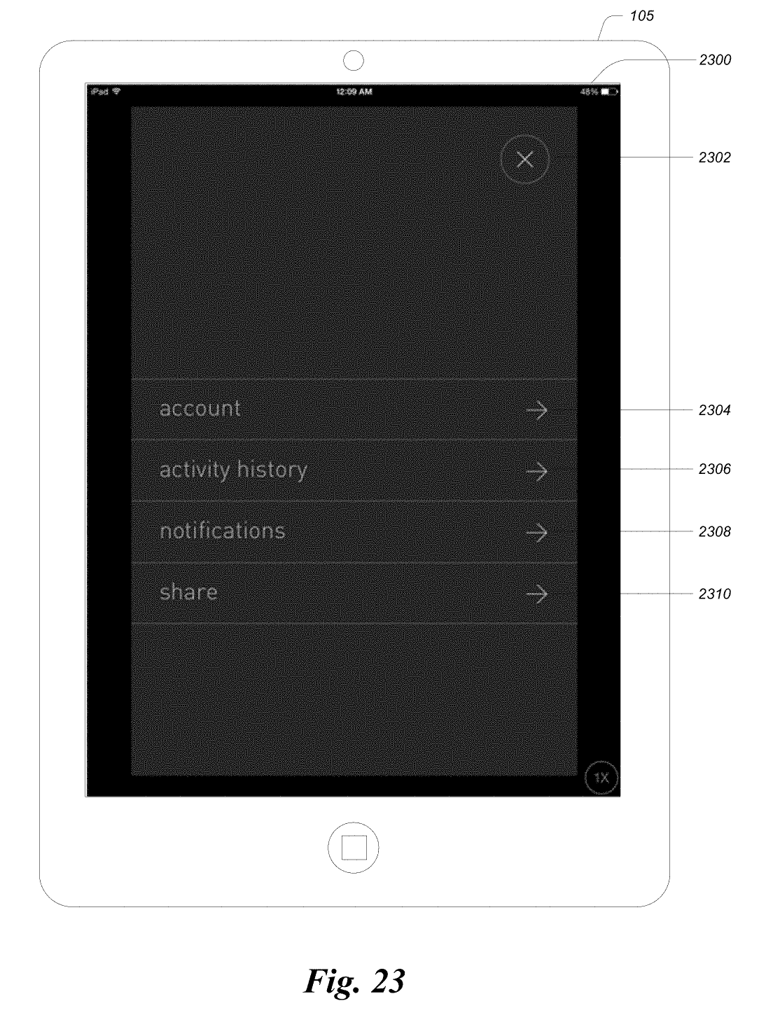

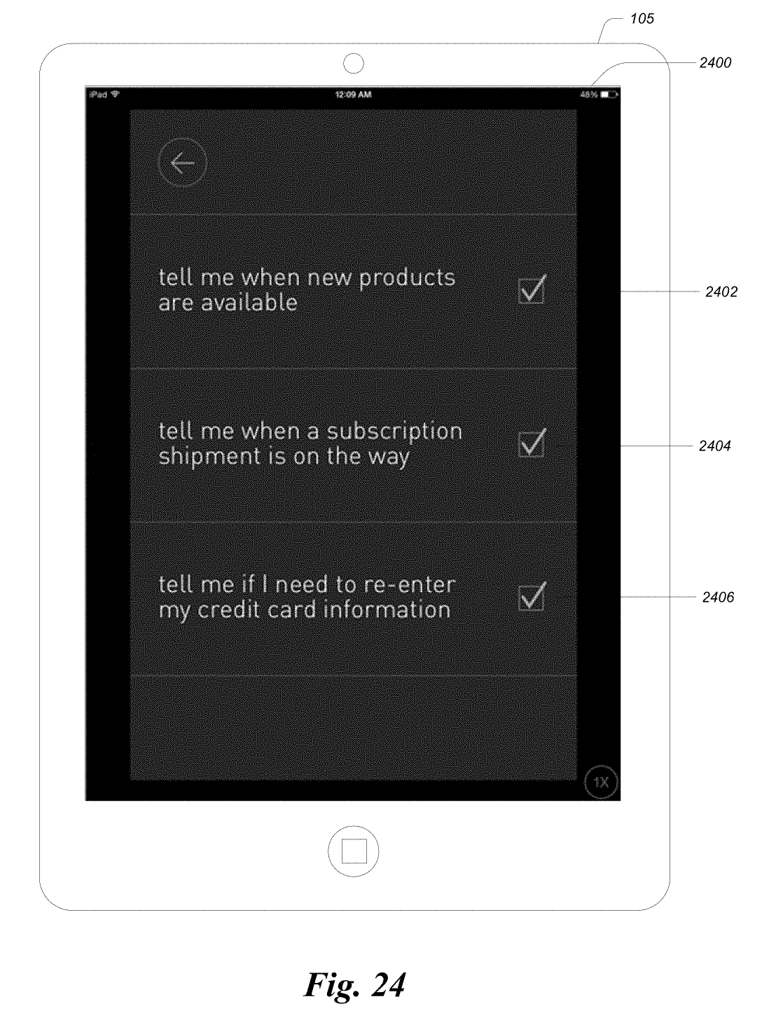

FIGS. 6-24 illustrate an example of a graphical user interface of a user information system for domestic products such as soap pumps, trash cans, and vanity mirrors, and related disposables or consumables, such as soap, hand sanitizer, lotion, and trash can liners or trash bags. FIG. 6 illustrates a sample user interface 600 of an example home or landing page for the app. User interface 600 may be presented, for example, when a user opens or accesses the domestic appliance management application, for example from an operating system desktop or home screen user interface. User interface 600 may include one or more display elements 602, 604, 606, and 608, each of which may be interactive and configured to accept and respond to user input and interaction. Display element 602, represented as a plus icon or symbol, may be selected by the user to add or register a domestic appliance to his or her user account in order to manage the domestic appliance via the app. In response to user selection of display element 602, a user interface or series of user interfaces (for example, user interfaces 700, 800, 900, of FIGS. 7, 8, and 9 respectively) may be presented for the user to add a product to his or her account. In response to user selection of display element 604, a user interface or series of user interfaces (for example, user interfaces 2300, 2400 of FIGS. 23 and 24, respectively) may be presented for the user to add account details and information to his or her account.

Display elements 606 and 608 may be presented as visual indicators of the user's current “position” within the app. For example, display element 606, represented as a smaller plus icon or symbol, may be highlighted or a certain color to indicate that the user is currently viewing the home or landing page, where the user can add new products and/or account information to his or her account as described above. “Product navigation” display element 608 may be presented to indicate or represent a product or domestic appliance that has been associated with the user's account. Display element 608 may be presented as a dot, which may be a certain color to represent a certain type of product or domestic appliance (for example, a blue dot may indicate a soap pump, a green dot may indicate a trash can, a purple dot may indicate a vanity mirror, and so on in various color combinations). In some instances display element 608 may be presented as an icon, symbol, or other graphic representing the product or domestic appliance. As more products or domestic appliances are added to or associated with the user's account, additional display elements 608 may be presented to correspond to each product. For example, if the user has added a soap pump, a trash can, and a vanity mirror to his or her account, three representative dots (or icons, etc.) may be presented at display element 608.

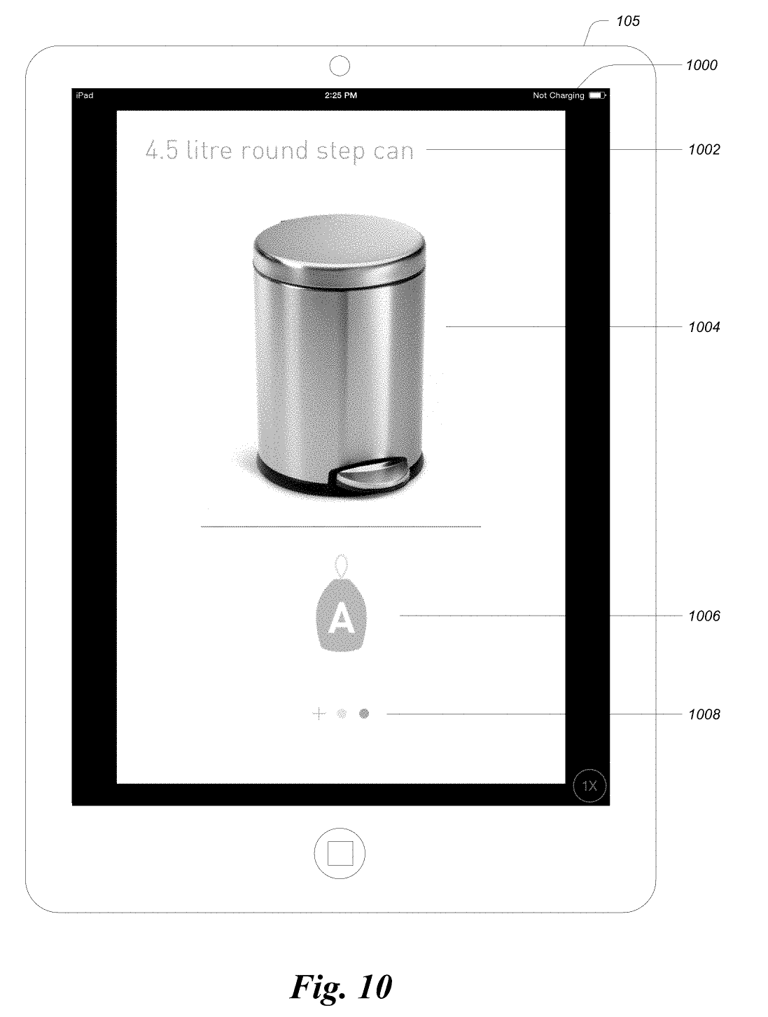

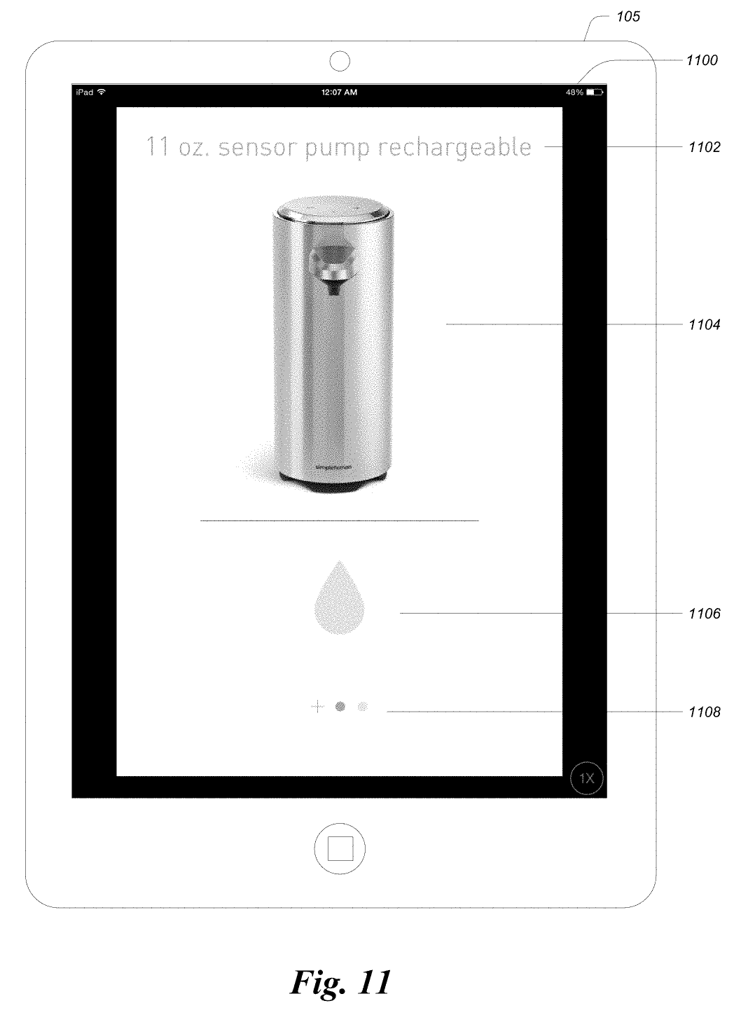

User interface 600 may enable various ways in which the user may navigate to additional user interfaces to manage his or her account and/or products. For example, in some embodiments, each dot (or icon, etc.) presented at display element 608 may be interactive such that in response to user selection of a respective dot, another user interface (such as user interfaces 1000 of FIG. 10 or user interface 1100 of FIG. 11) presenting information and/or management options for the associated product may be displayed, Or, as another example, the user interface 600 may be configured to respond to a user swipe gesture (e.g., a right-to-left swipe touch gesture), a mouse click, a keyboard selection, or other similar interaction to cause the display to switch to one or more additional user interfaces. For example, a right-to-left swipe gesture may cause user interface 1000 or FIG. 10 to be presented or displayed. Another right-to-left swipe gesture with respect to user interface 1000 may cause user interface 1100 of FIG. 11 to be presented or displayed. A left-to-right swipe gesture with respect to user interface 1000 may cause user interface 600 to be re-presented or re-displayed; and so on.

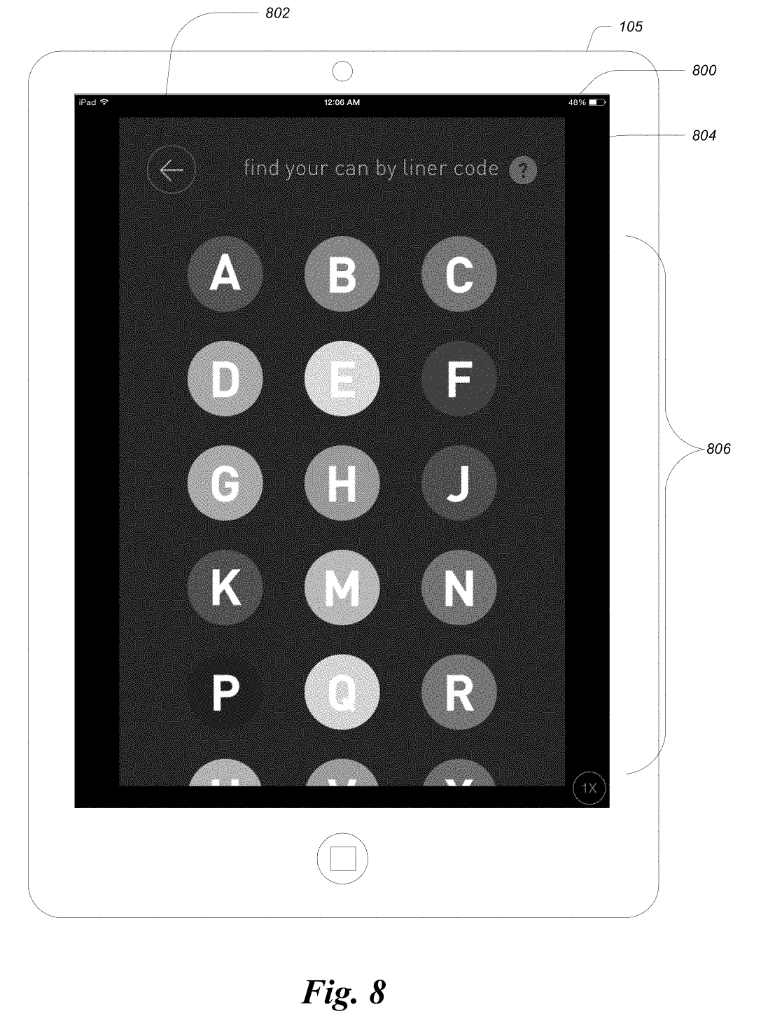

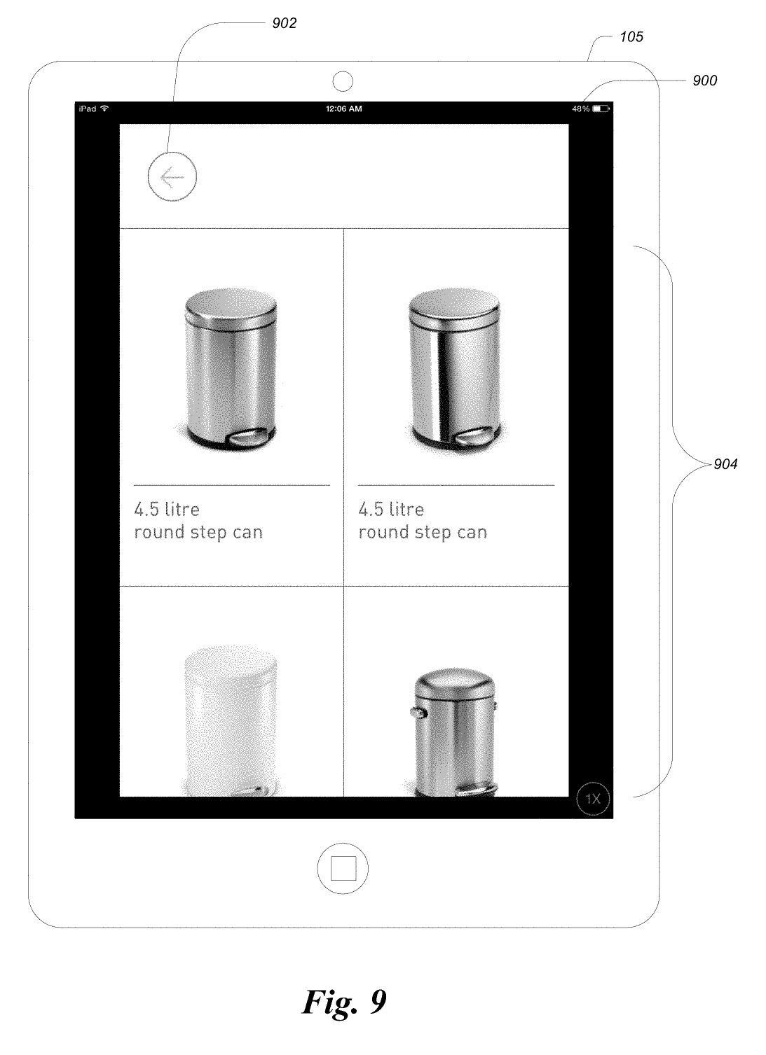

FIG. 7 illustrates a sample user interface 700 of an example add product page for a domestic appliance management application. User interface 700 may be presented, for example, in response to user selection of display element 602 of user interface 600. User interface 700 may include one or more display elements 702, 704, and 706, each of which may be interactive and configured to accept and respond to user input and interaction. Display element 702, represented as an “X” icon or button, may be selected by the user to cancel the add product request, which may in turn cause the “home page” user interface 600 to be displayed again. Display element 704, represented as a trash can graphic or icon, may be selected by the user to add a trash can to his or her account. In response to user selection of display element 704, one or more additional user interfaces (such as user interface 800 of FIG. 8 and user interface 900 of FIG. 9) may be displayed to enable the user to complete the process of selecting and adding a trash can to his or her account. Display element 706, represented as a soap pump graphic or icon, may be selected by the user to add a soap pump to his or her account. In response to user selection of display element 706, one or more additional user interfaces (similar to those such as user interface 800 of FIG. 8 and user interface 900 of FIG. 9 for adding a trash can) may be displayed to enable the user to complete the process of selecting and adding a soap pump to his or her account. Although not shown in FIG. 7, additional products may be added similarly via one or more additional graphics or icons presented in user interface 700. For example, one or more additional display elements may be displayed to enable the user to add one or more additional products (e.g., a vanity mirror or other type of domestic appliance which may have a consumable resource which the user may wish to monitor and/or manage actively or passively). FIG. 8 illustrates a sample user interface 800 of an example add trash can selection page for a domestic appliance management application, in this case by user selection of a code designated for a liner associated with a particular trash can or with a plurality of trash cans. User interface 800 may be presented, for example, in response to user selection of display element 704 of user interface 700. User interface 800 may include one or more display elements 802, 804, and 806, each of which may be interactive and configured to accept and respond to user input and interaction. Display element 802, represented as a back arrow icon or button, may be selected by the user to cancel the current add product request, which may in turn cause the “add product” user interface 700 to be displayed again. Display element 804, represented as a question mark icon or button, may be selected by the user to view additional information explaining how the user may identify and use a product feature (for example, a trash can liner code, as shown in FIG. 8) to identify and select the correct product to add to his or her account. Display element 806, represented in FIG. 8 as a grid of alphanumeric codes, may be displayed for the user to select the product feature (for example, a trash can liner code). In response to selection of a particular product feature, the app or the DAC system 100 may filter the list of potential products, and another user interface (such as user interface 900 of FIG.9) may be displayed showing the filtered list of products matching the selected product feature.

FIG. 9 illustrates a sample user interface 900 of another example add trash can selection page for a domestic appliance management application. User interface 900 may be presented, for example, in response to user selection of one of the product features (for example, liner code) at display element 806 of user interface 800. User interface 900 may include one or more display elements 902 and 904, each of which may be interactive and configured to accept and respond to user input and interaction. Display element 902, represented as a back arrow icon or button, may be selected by the user to return to the previous step in the add product process, which may in turn cause the “add product” user interface 800 to be displayed again. Display element 904 may present the filtered list of one or more products matching the selected product feature (for example, trash cans which use a particular liner associated with the selected liner code). Each matching product may be represented in display element 904 as an icon, graphic, or text in various combinations (for example, a picture and text description as shown in FIG. 9). The user may select one of the matching products to add the product to his or her account. In some embodiments, an additional confirmation user interface (not illustrated) may be displayed for the user to confirm the selection. Once the product has been added to his or her account, a product page user interface (for example, user interface 1000 or user interface 1100 of FIGS. 10 and 11, respectively) may be displayed, and an additional dot (or icon, etc.) may be added to the product navigation display element 608.

FIG. 10 illustrates a sample user interface 1000 of an example trash can product home page for a domestic appliance management application. User interface 1000 may be presented, for example, in response to a user adding a new trash can product to his or her account, as described above, and/or in response to the user navigating to the trash can product page via one of the navigation interaction processes described with reference to FIG. 6. User interface 1000 may include one or more display elements 1002, 1004, 1006, and 1008, each of which may be interactive and configured to accept and respond to user input and interaction. Display element 1002 may include, for example, a description of the product. Display element 1004 may present a graphic or picture of the product so that the user can quickly and easily identify the domestic appliance. Display element 1004 may also be interactive such that in response to user selection of the graphic or picture of the product (for example, the user touches or clicks on that portion of the display area), one or more additional user interfaces may be presented to enable the user to view and/or provide additional information about the product. For example, as discussed further below with reference to an example soap pump, user interfaces 1200, 1300, 1400, 1500, and 1600 of FIGS. 12, 13, 14, 15, and 16 respectively may be presented to the user responsive to selection of the product image.

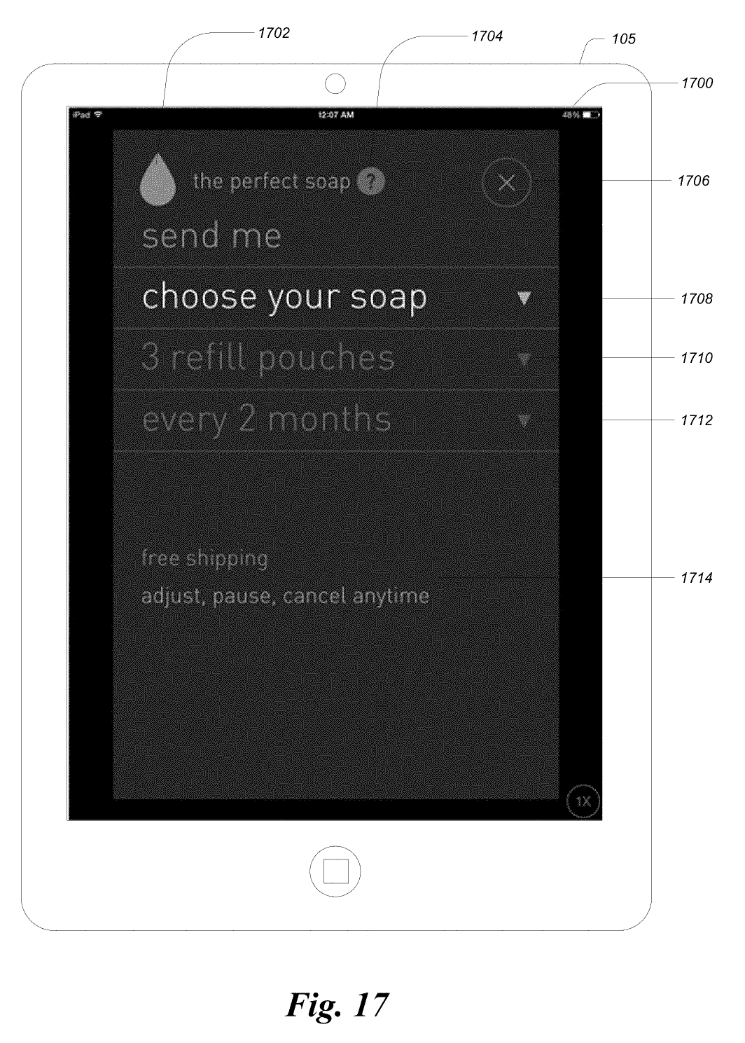

With continued reference to FIG. 10, display element 1006 may present a graphic or picture (or multiple graphics or pictures) representing a consumable resource (or multiple consumable resources) associated with the product or domestic appliance. For example, as shown in FIG. 10, display element 1006 is represented by a trash can liner icon (which, as illustrated, may include further detail such as the liner code). As shown and described, the user interface 100 can be enabled or configured to receive, from the consumable resource management user interface, a user input indicating a type of domestic appliance, and automatically determine the consumable resource, based at least in part on the received user input indicating the type of domestic appliance. Display element 1006 may also be interactive such that in response to user selection of the graphic or picture of the consumable resource (for example, the user touches or clicks on that portion of the display area), one or more additional user interfaces may be presented to enable the user to view additional information about the consumable resource, order refills, and/or manage scheduled deliveries. For example, as discussed further below with reference to an example soap pump, user interfaces 1700, 1800, 1900, 2000, 2100, and 2200 of FIGS. 17, 18, 19, 20, 21 and 22 respectively may be presented to the user responsive to selection of the consumable resource image.

With continued reference to FIG. 10, display element 1008 may be presented similar to the “product navigation” display element 608 of FIG. 6, with one or more dots (or icons, etc.) to indicate or represent one or more products or domestic appliances that have been associated with the user's account and which the user may navigate between as discussed previously.

FIG. 11 illustrates a sample user interface 1100 of an example soap pump product home page for a domestic appliance management application. User interface 1100 may be presented, for example, in response to a user adding a new soap pump product to his or her account, as described above in the example scenario for adding a trash can; and/or in response to the user navigating to the soap pump product page via one of the navigation interaction processes described with reference to FIG. 6. User interface 1100 may include one or more display elements 1102, 1104, 1106, and 1108, each of which may be interactive and configured to accept and respond to user input and interaction. Each of these display elements may be configured similarly to the display elements described in detail above with respect to user interface 1000 of FIG. 10. For example, display element 1102 may provide any of the features described with reference to display element 1002; display element 1104 may provide any of the features described with reference to display element 1004; display element 1106 may provide any of the features described with reference to display element 1006; and display element 1108 may provide any of the features described with reference to display element 1008.

FIG. 12 illustrates a sample user interface 1200 of an example soap pump product detail page for a domestic appliance management application. User interface 1200 may be presented, for example, in response to user selection of display element 1104 of FIG. 11. (Although not illustrated in the figures, a similar user interface for an example trash can product detail page may be presented, for example, in response to user selection of display element 1004 of FIG. 10.) User interface 1200 may include one or more display elements 1202, 1204, 1206, and 1208, each of which may be interactive and configured to accept and respond to user input and interaction. Display element 1202 may include, for example, a description of the product. Display element 1204, represented as an “X” icon or button, may be selected by the user to close the product detail page, which may in turn cause the “soap pump product page” user interface 1100 (or the trash can product user interface 1000, in another scenario) to be displayed again. Display element 1206 may be a user input text box by which the user may provide a nickname for the product. This may be beneficial so that the user may quickly identify the product as used in a particular location in the user's home (for example, a kitchen, a bathroom, etc.).

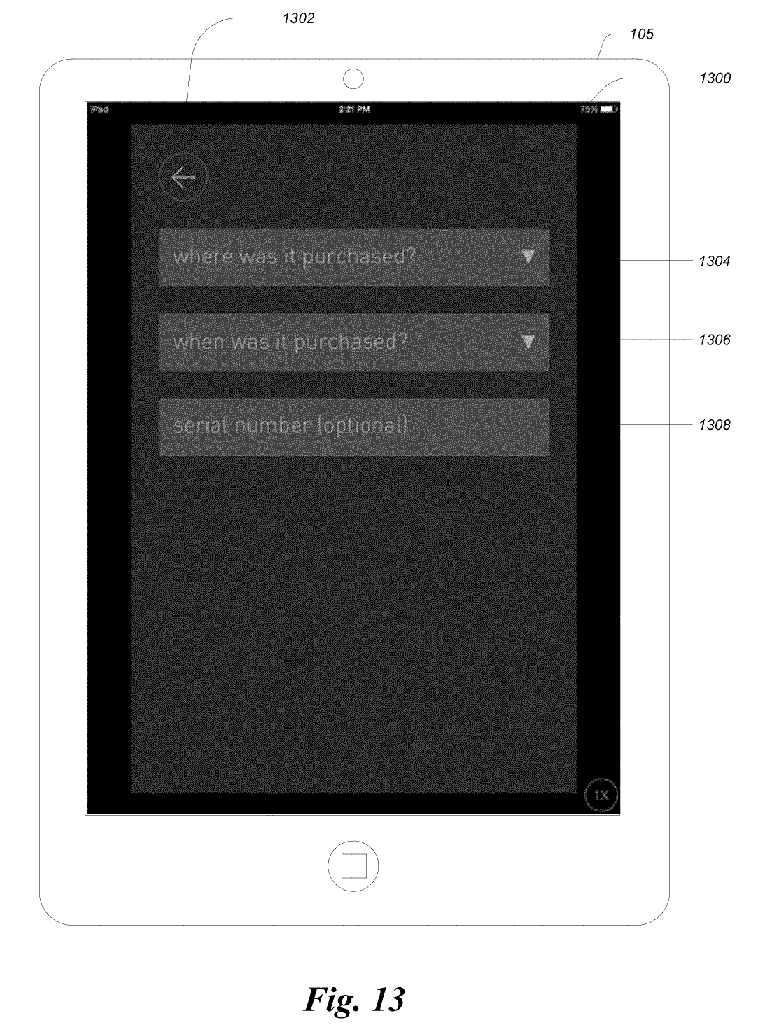

As shown in FIG. 12, display element 1208 may present a user-selectable option for the user to register the product with the user information system, which may enable additional benefits as described herein including automatic notification of consumable resource status, special offers, and other useful information such as recalls, updates, and other information of which the user may find useful to be actively or passively notified. In response to user selection of display element 1208, one or more registration user interfaces (for example, user interfaces 1300, 1400, and 1500 of FIGS. 13, 14, and 15, respectively) may be provided for the user to provide product registration information.

Also shown in FIG. 12, display element 1210 may present a user-selectable option for the user to view tips and support information associated with the product. Such tips and support information may be provided, for example, by the user information system to assist the user in efficient use and/or management of the product, and/or to provide useful support information such as product updates, recall notices, and the like.

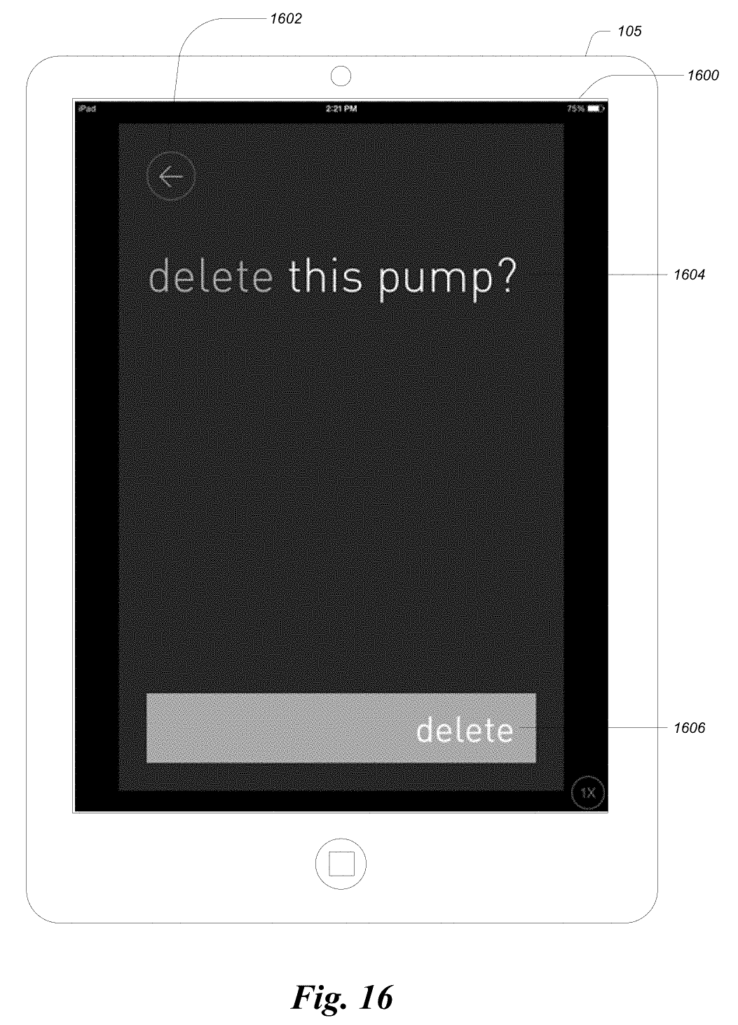

Also shown in FIG. 12, display element 1212 may present a user-selectable option for the user to remove the product from his or her account. In response to user selection of display element 1212, a confirmation user interface (such as user interface 1600 of FIG. 16) may be provided for the user to confirm his or her intent to remove the product from his or her account. Removing the product may be important to the user who, for example, may have purchased a new product to replace an older one which the user had discontinued using and no longer wishes to manage via the domestic appliance management app.

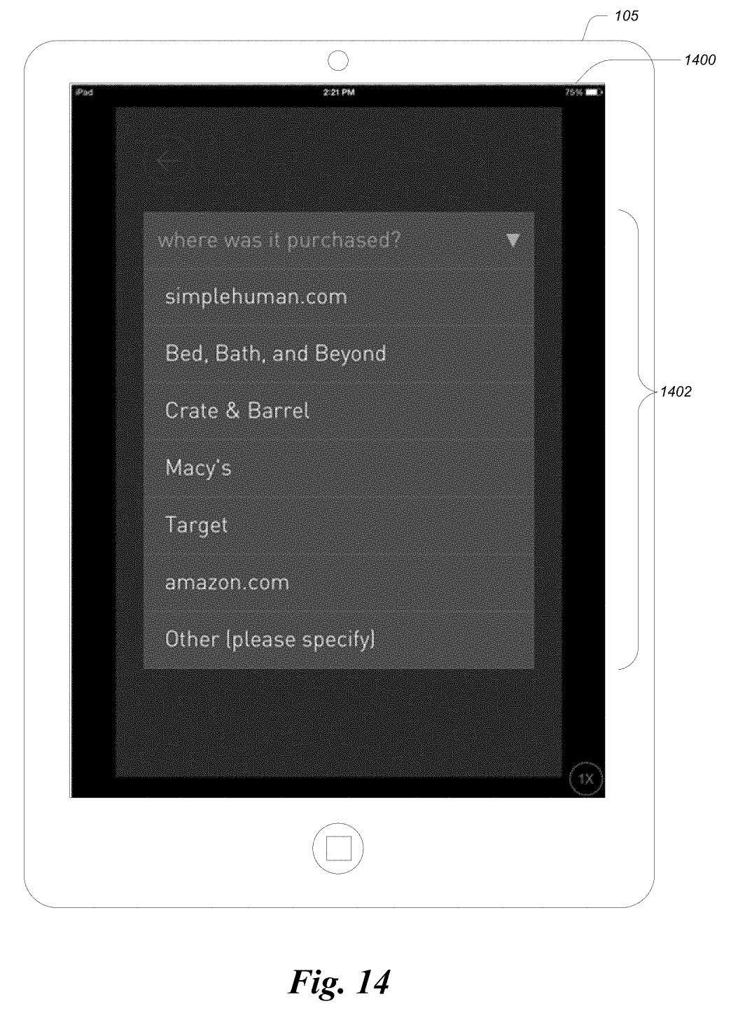

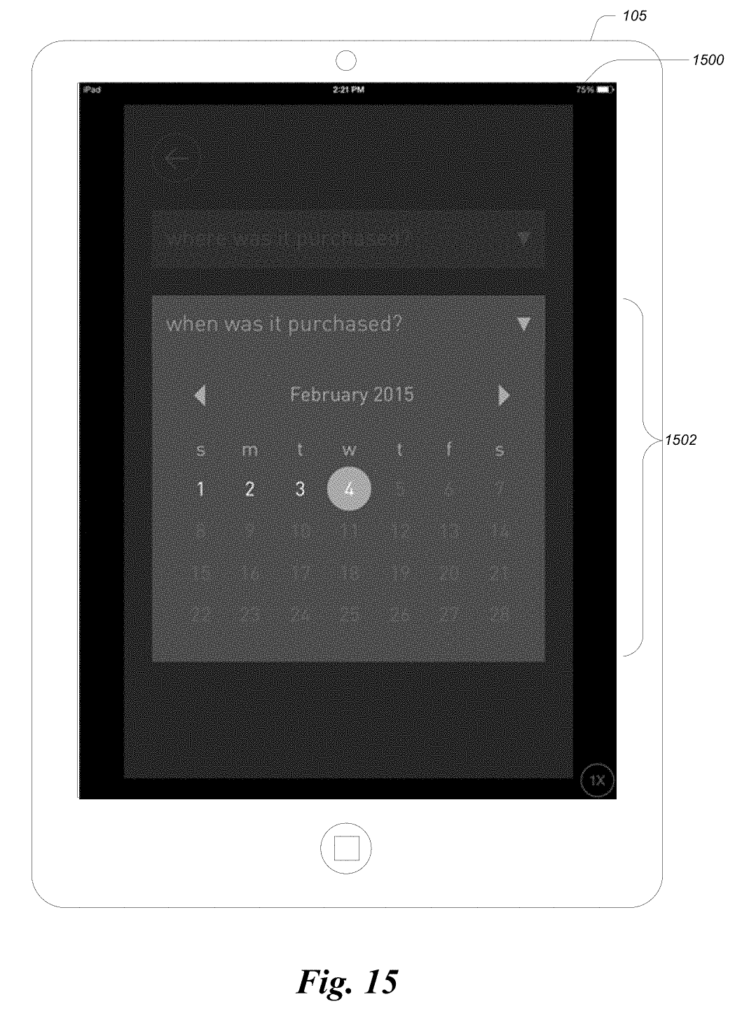

FIG. 13 illustrates a sample user interface 1300 of an example product registration page for a domestic appliance management application. User interface 1300 may be presented, for example, in response to user selection of display element 1208 of user interface 1200. User interface 1300 may include one or more display elements 1302, 1304, 1306, and 1308, each of which may be interactive and configured to accept and respond to user input and interaction. Display element 1302, represented as a back arrow icon or button, may be selected by the user to cancel the current register product request, which may in turn cause the “product detail” user interface 1200 to be displayed again. Display element 1304 may be presented to enable the user to provide information about where the product was purchased. User selection of display element 1304 may cause display of a popover menu or dropdown list, for example such the one shown in user interface 1400 of FIG. 14. Display element 1306 may be presented to enable the user to provide information about when the product was purchased. User selection of display element 1306 may cause display of a date selection user interface control, for example such the calendar shown in user interface 1500 of FIG. 15. Display element 1306 may be presented to enable the user to provide a serial number associated with the product. In some embodiments, certain domestic appliances (such as the example appliances discussed herein, including the example soap dispenser of FIG. 2) may be configured to provide serial number, model number, and/or other product registration automatically to the user information system in order to streamline the adding and registering of products for management via the domestic appliance management app.

FIG. 14 illustrates a sample user interface 1400 of an example product registration page for a domestic appliance management application. User interface 1400 may be presented, for example, in response to user selection of display element 1304 of user interface 1300. User interface 1400 may include one or more display elements 1402 which may be interactive and configured to accept and respond to user input and interaction. Display element 1402 may be presented to enable the user to provide information about where the product was purchased, which may be selected from a list of retailers which carry the product, or provided by the user via an “other” option.

FIG. 15 illustrates a sample user interface 1500 of an example product registration page for a domestic appliance management application. User interface 1500 may be presented, for example, in response to user selection of display element 1306 of user interface 1300. User interface 1500 may include one or more display elements 1502 which may be interactive and configured to accept and respond to user input and interaction. Display element 1502 may be presented to enable the user to provide information about when the product was purchased. A calendar user interface control element as illustrated may be provided, although any other date picker or selection control may also be presented in various embodiments.

FIG. 16 illustrates a sample user interface 1600 of an example product removal page for a domestic appliance management application. User interface 1600 may be presented, for example, in response to user selection of display element 1212 of user interface 1200. User interface 1600 may include one or more display elements 1602, 1604, and 1606, each of which may be interactive and configured to accept and respond to user input and interaction. Display element 1602, represented as a back arrow icon or button, may be selected by the user to cancel the current remove product request, which may in turn cause the “product detail” user interface 1200 to be displayed again. Display element 1604 may present a confirmation message to confirm the user's intent to remove the product (for example, the soap pump). Display element 1606 may present a “delete” button for the user to complete the removal process and remove the product from his or her account.

FIG. 17 illustrates a sample user interface 1700 of an example consumable resource refill and ordering page for a domestic appliance management application. User interface 1700 may be presented, for example, in response to user selection of display element 1106 of user interface 1100 (for example, to order and/or manage delivery of a soap refill). In another embodiment, a variation of user interface 1700 may be presented in response to user selection of display element 1006 of user interface 1000 (for example, to order and/or manage delivery of a trash can liner refill). User interface 1700 may include one or more display elements 1702, 1704, 1706, 1708, 1710, 1712, and 1714, each of which may be interactive and configured to accept and respond to user input and interaction. Display element 1702 may present information describing the type of consumable resource (for example, a soap) that is to be refilled. Display element 1704, represented as a question mark icon or button, may be selected by the user to view additional information about the consumable resource that is to be refilled. Display element 1706, represented as an “X” icon or button, may be selected by the user to close the refill detail page, which may in turn cause the “product page” user interface 1100 (or user interface 1000) to be displayed again.

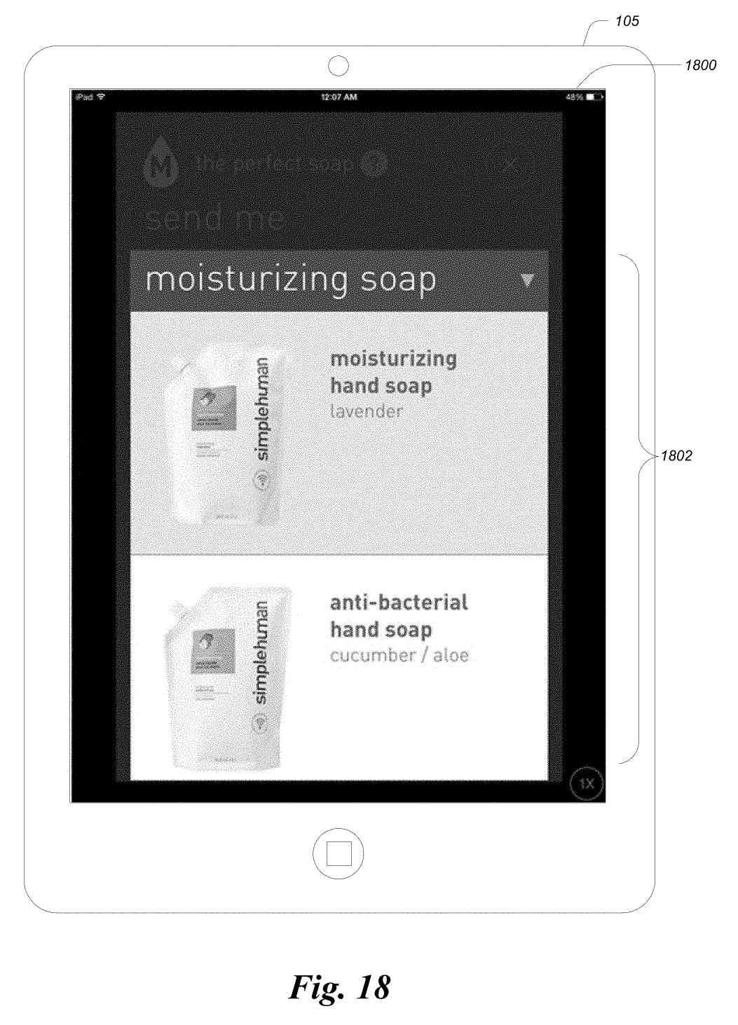

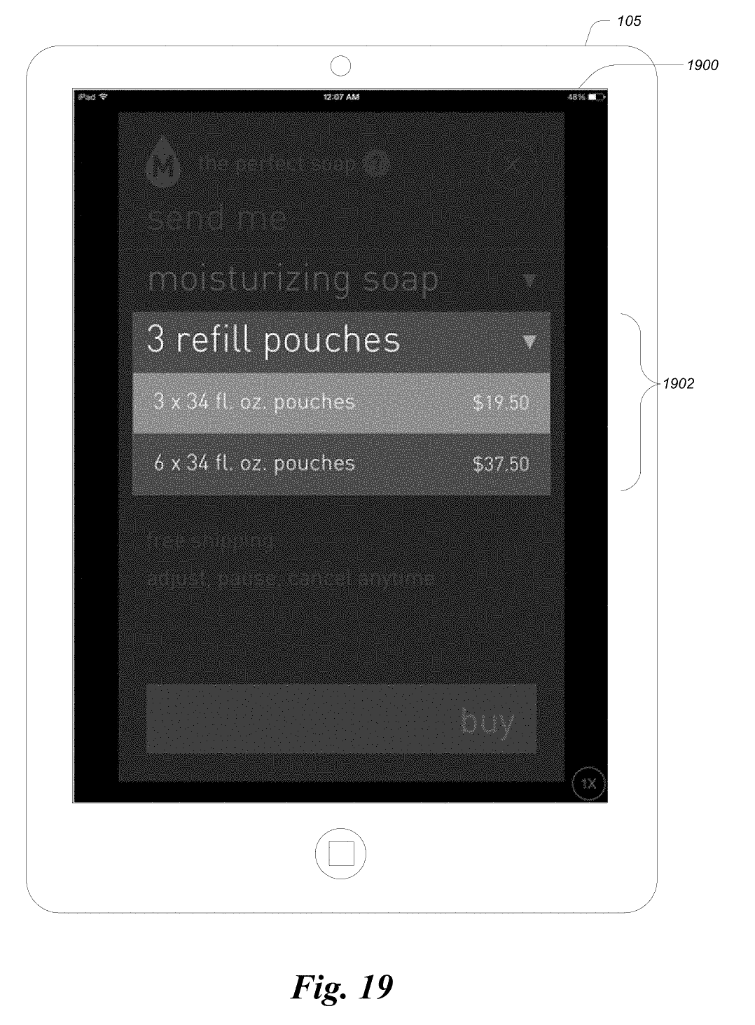

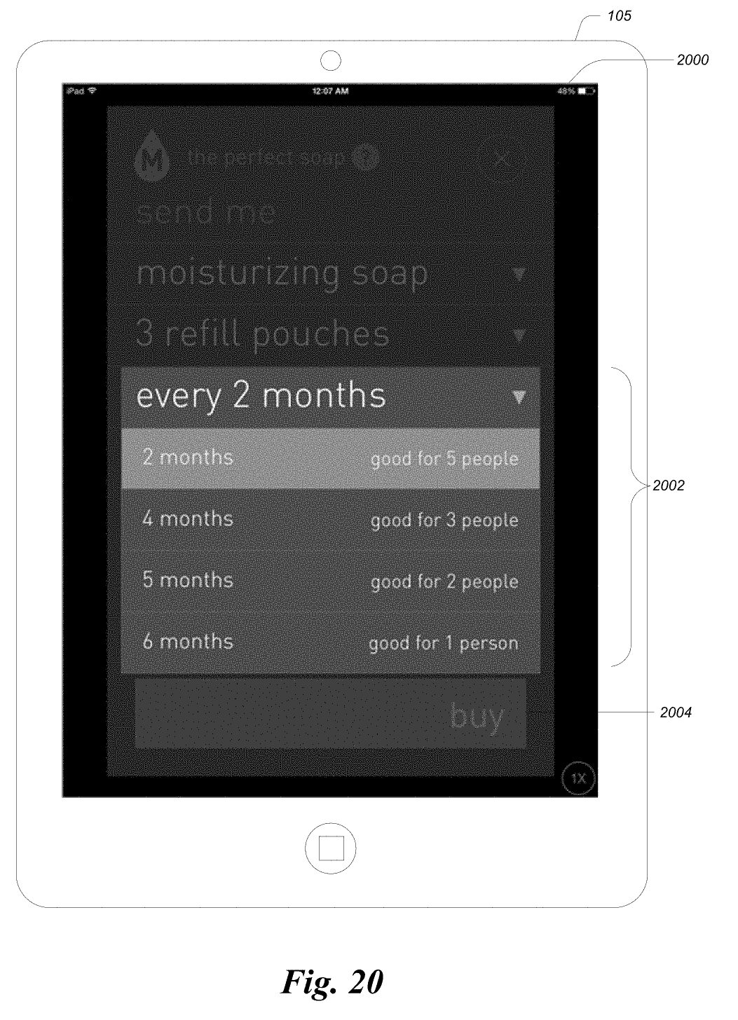

As shown in FIG. 17, display element 1708 provides a user-selectable option for the user to choose a particular soap (or other consumable resource, in other scenarios). In response to user selection of display element 1708, a dropdown list or other menu selection interactive control listing types of available soap (or other consumable resource) may be displayed, such as the one shown in example user interface 1800 of FIG. 18. Display element 1710 provides a user-selectable option for the user to indicate a selection of how many units of the refill item (for example, a number of soap pouches) to order. In response to user selection of display element 1710, a dropdown list or other menu selection interactive control of refill options and associated prices may be displayed, such as the one shown in example user interface 1900 of FIG. 19. Display element 1712 provides a user-selectable option for the user to indicate a delivery schedule for the refill order (for example, every 2 months as illustrated or on some other periodic basis such as every “N” number of days, weeks, months, and so on). In response to user selection of display element 1712, a dropdown list or other menu selection interactive control of delivery schedule options and other information may be displayed, such as the one shown in example user interface 2000 of FIG. 20. Display element 1714 provides additional information about the refill order request, including shipping cost information and a reminder that the refill order may be adjusted, paused, or canceled at any time. For example, if the user finds that he or she is using a consumable resource faster (or slower) than anticipated, the user may update the delivery schedule (discussed further below) to request a refill sooner (or later), and/or increase (or decrease) the number of units of the refill item to be delivered. Or, if the user has discontinued use of a particular product, he or she may wish to cancel the refill order altogether.

FIG. 18 illustrates a sample user interface 1800 presenting an example consumable resource item selection UI control for a domestic appliance management application. User interface 1800 may be presented, for example, in response to user selection of display element 1708 of user interface 1700. User interface 1800 may include one or more display elements including display element 1802 which may be interactive and configured to accept and respond to user input and interaction. Display element 1802 may present a dropdown list or other menu selection interactive control listing one or more user-selectable types of available soap (or other consumable resource). In some embodiments if the list of types of available soap or other consumable resource is too long to fit on a single display screen the list may be scrolled through by the user, for example by a bottom-to-top swipe gesture interaction with a touch-enabled display. The list of types of available soap (or other consumable resource) may include various types of descriptive information including, for example, a product photograph or image and/or a description of the item as shown in FIG. 18.

FIG. 19 illustrates a sample user interface 1900 presenting another example consumable resource item selection UI control for a domestic appliance management application. User interface 1900 may be presented, for example, in response to user selection of display element 1710 of user interface 1700. User interface 1900 may include one or more display elements including display element 1902 which may be interactive and configured to accept and respond to user input and interaction. Display element 1902 may present a dropdown list or other menu selection interactive control listing one or more refill options and associated prices for the currently selected consumable resource type (for example, for the selected type of soap). In some embodiments if the list of types of available refills is too long to fit on a single display screen, the list may be scrolled through by the user, for example by a bottom-to-top swipe gesture interaction with a touch-enabled display. The list of types of available refills may include various types of descriptive information including, for example, an amount included in each unit of the refill (for example, 34 fluid ounces per pouch) and an associated price.

FIG. 20 illustrates a sample user interface 2000 presenting another example consumable resource item selection UI control for a domestic appliance management application. User interface 2000 may be presented, for example, in response to user selection of display element 1712 of user interface 1700. User interface 2000 may include one or more display elements including display element 2002 which may be interactive and configured to accept and respond to user input and interaction. Display element 1902 may present a dropdown list or other menu selection interactive control listing one or more delivery schedule options and other information for the currently selected consumable resource type (for example, for the selected type of soap). In some embodiments, if the list of delivery schedule options is too long to fit on a single display screen, the list may be scrolled through by the user, for example by a bottom-to-top swipe gesture interaction with a touch-enabled display. The list of delivery schedule options and other information may include various types of descriptive information including, for example, a frequency of delivery (for example, every 2 months, every 4 months, and so on) and a recommendation of how many people each delivery option is generally good for (for example, a refill every 2 months might be better suited for 5 people since the likely use more soap than 1 person, who might only need a refill every 6 months). In some embodiments, the list of delivery schedule options may display, in addition to or instead of the foregoing information, any other appropriate information to help inform the user's decision about when or how often to purchase the consumables, such as one or more indicators of how common a choice is for other users (e.g., “Most Common” or “Less Common” or “More Common”) or one or more indicators providing further explanation about the effect of a particular option, such as pointing out that a selection of a longer duration provides less frequent deliveries of consumables (e.g., by displaying “more frequent” or a similar indicator next to a shorter delivery period, such as 2 months or 4 months, and/or by displaying “less frequent” or a similar indicator next to a longer delivery period, such as 5 months or 6 months).

Once a user has finished making selections of the type of consumable resource, refill option, and/or delivery schedule, the user may select the “Buy” option shown at display element 2004 shown in FIG. 20 to place the refill order. Depending on the embodiment, the user may be presented with an additional user interface to provide billing, shipping, and payment related information. In some embodiments the user may have previously provided this information in which case the order may be placed directly. The order may be sent to the user information system for further processing.

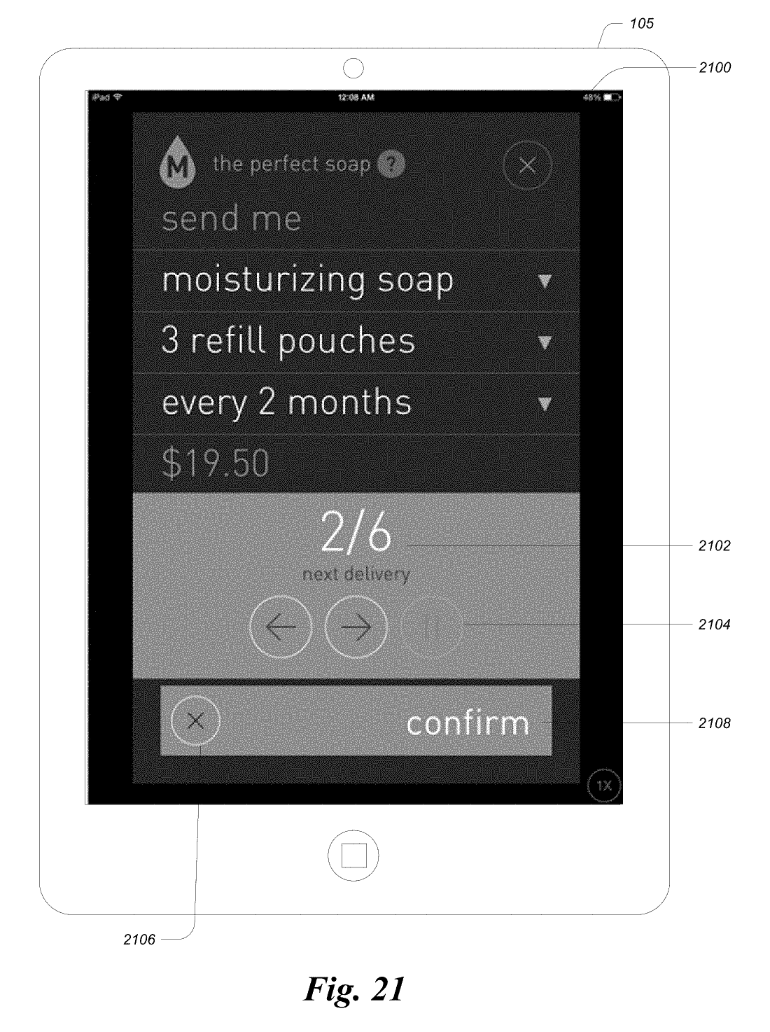

FIG. 21 illustrates a sample user interface 2100 of another example consumable resource refill and ordering page for a domestic appliance management application. User interface 2100 may be presented, for example, in response to user selection of display element 1106 of user interface 1100 (for example, to order and/or manage delivery of a soap refill). In another embodiment, a variation of user interface 2100 may be presented in response to user selection of display element 1006 of user interface 1000 (for example, to order and/or manage delivery of a trash can liner refill). In particular, user interface 2100 may be presented in response to a user selection or request to modify an existing refill order. User interface 2100 may include one or more display elements 2102, and 2104, each of which may be interactive and configured to accept and respond to user input and interaction. Display element 2102 provides an indication of when the next delivery of the refill is scheduled to occur. Display element 2104 provides one or more user selectable options for the user to modify this delivery, including for example an option to move the delivery date up to a closer date, push the delivery date out to a date farther away, or to pause delivery. Display element 2106 represented as an “X” icon or button, may be selected by the user to cancel the modify order request to keep the existing refill order unchanged. Display element 2108, represented as a “confirm” button, may be selected by the user to submit the modify order request and cause the delivery of the refill to be updated according to the newly selected delivery options.

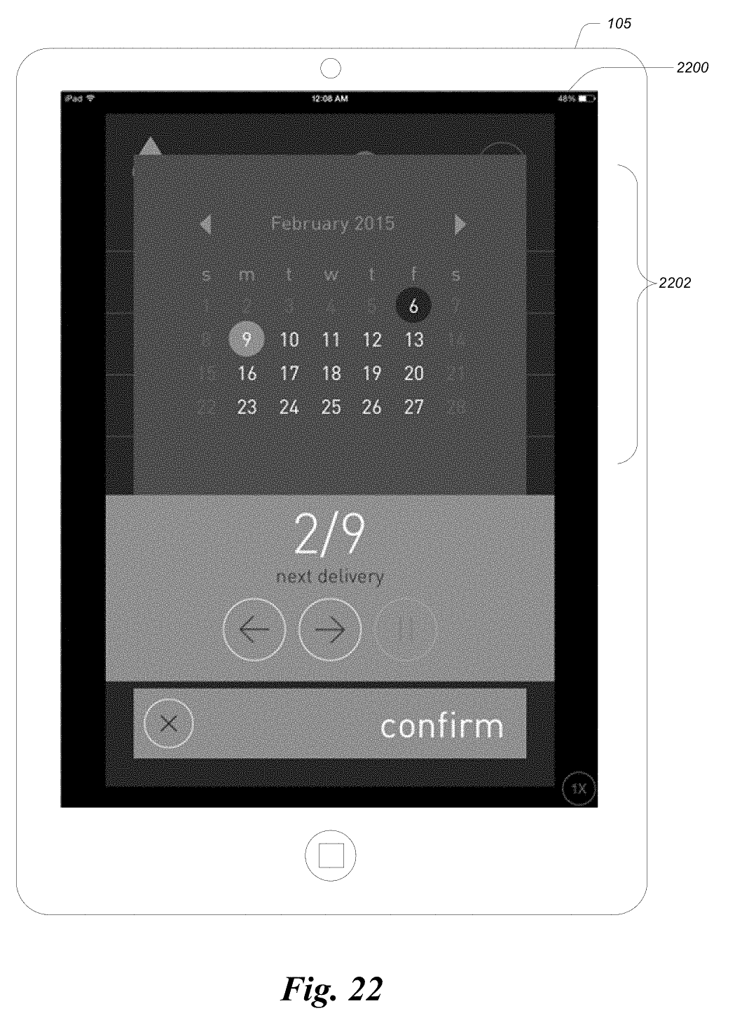

FIG. 22 illustrates a sample user interface 2200, a variation of user interface 2100, as a consumable resource refill and ordering page for a domestic appliance management application. In user interface 2100, an optional calendar display element 2102 may also be presented showing the current date and the date of the next scheduled delivery. This way the user can quickly view the delivery information and if desired choose a new delivery date by touching, clicking, or otherwise selecting a date on the calendar.

FIG. 23 illustrates a sample user interface 2300 of an example account settings page for a domestic appliance management application. User interface 2300 may be presented, for example, in response to user selection of display element 604 of user interface 600. User interface 2300 may include one or more display elements 2302, 2304, and 2306, each of which may be interactive and configured to accept and respond to user input and interaction. Display element 2302, represented as an “X” icon or button, may be selected by the user to return to the “home page” user interface 600. Display element 2304, may enable the user to view and/or modify account details and information in another user interface (not shown), such as name, email address, shipping and billing information, account name, account password, and the like. Display element 2306 may enable the user to view account history details and information such as past orders, consumable resource usage patterns and related data for one or more products associated with the user's account, and other types of account history data. Display element 2308 may enable the user to view and/or modify notification preferences for when notifications are to be sent to the user. An example notification preferences user interface is shown in FIG. 24. Display element 2310 may enable the user to share information, such as on a social media network or blog.

FIG. 24 illustrates a sample user interface 2400 of an example account notification preferences page for a domestic appliance management application. User interface 2400 may be presented, for example, in response to user selection of display element 2308 of user interface 2300. User interface 2400 may include one or more display elements 2402, 2404, and 2406, each of which may be interactive and configured to accept and respond to user input and interaction. Each of display elements 2402, 2404, and 2406 represent respective notifications which the user may wish to receive regarding his or her account or products, including whether to be notified when new products are available, whether to be notified when a subscription shipment is on the way, and whether the user may need to re-enter credit card or other payment information in order to ensure continued timely delivery of subscription shipments. Additional notification preferences may be enabled, such as whether the user would like to be notified if a consumable resource on one or more products or domestic appliances associated with the user's account is running low and may need to be refilled sooner than anticipated; whether the user would like to be notified if a coupon or special offer is available for one or more products or domestic appliances associated with the user's account; whether the user would like to be notified when he or she is in a location nearby to where a refill may be purchased; and so on for any other type of notification or alert described in this disclosure.

Although the refill ordering process and options described with reference to the figures above may involve several manual steps, some of all of the refill ordering may be configured for automatic renewal or updating based, for example, on detected and/or reported resource consumption levels for various domestic appliances configured to automatically and periodically detect consumption levels and report consumption data to the user information system. In some embodiments the user may manually override any such automatic refill fulfillment based on detected consumption, such as by the user interfaces described above, while in other embodiments the user may enable or allow such automatic refill fulfillment once any required information has been provided and processed by the user information system (for example, any necessary product registration and billing and shipping information as may be needed to setup automatic detection of a needed refill, shipment of the refill, and processing of payment on behalf of the user).

### Additional Features

In general, any of the structures, materials, features, routines, algorithms, processes, methods and/or criteria disclosed and/or illustrated herein for domestic appliance communications, monitoring, and/or processing of information, can be used individually or in combination with any of the other structures, materials, routines, algorithms, processes, methods or criteria disclosed and/or illustrated herein.

The domestic appliance communication system 100, domestic appliances 106 and/or user computing devices 105 may communicate directly or indirectly via a network 160. The computing device 105 may be connected to the network 160 may include any combination of networks, such as local area, wide area, Internet, etc., by way of a wired network, such as an Ethernet LAN or cable modem, or via a wireless method, such as through an 802.11 access point or via a cell phone network. The network 160 allows computing devices to send (i.e. transmit) and receive electronic transmissions.

In some embodiments, the domestic appliance communication system 100 may be configured differently, include different components or modules, and/or omit some components or modules shown in FIG. 1. For example, In some embodiments, domestic appliance communication system 100 includes one or more hardware processors in communication with a computer readable medium storing software modules including instructions that are executable by the one or more hardware processors, and one or more software modules. The one or more hardware processors may include, for example, digital logic circuitry. The one or more software modules may instruct a computing system to execute the various methods, approaches, and/or techniques as described herein.

As described above, the domestic appliance communication system 100 can be implemented by a computing system that includes one or more physical servers or other computing machines, such as several computing machines interconnected via a network. Thus, each of the components depicted in the domestic appliance communication system 100 can include hardware and/or software for performing various features. In some embodiments, the domestic appliance communication system 100 is implemented in association with a web site or collection of web sites. Various disclosed features can be incorporated into a mobile device operating system, a mobile application, a domestic appliance communication site or service, a social networking service, or any combination of these.

The domestic appliance communication system 100 can include one or more servers for receiving and responding to network requests from the user computing device(s) 105. The one or more servers can include web servers, application servers, database servers, combinations of the same, or the like. In some embodiments, the network 160 is a publicly accessible network of linked networks, possibly operated by various distinct parties, such as the Internet. In some embodiments, the network 160 may be a private network, such as, for example, a home or corporate network that is wholly or partially inaccessible to non-privileged users. In still other embodiments, the network 160 may include one or more private networks with access to and/or from the Internet. User computing devices 105 may be any type of personal computer or mobile computing device (such as a smart phone, tablet, electronic book reader, or any other type of portable computing device).

The processing of the various components of the domestic appliance communication system 100 can be distributed across multiple machines, networks, and other computing resources. The various components of the domestic appliance communication system 100 can also be implemented in one or more virtual machines, rather than in dedicated servers. Likewise, the data repositories shown can represent physical and/or logical data storage, including, for example, storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

In some embodiments, the domestic appliance communication system 100 may be configured differently than illustrated in the figures above. For example, various functionalities provided by the illustrated modules can be combined, rearranged, added, or deleted. In some embodiments, additional or different processors or modules may perform some or all of the functionalities described with reference to the example embodiment illustrated in the figures above. Many implementation variations are possible.

In some embodiments, the domestic appliance communication system 100 may be implemented on, or in communication with, one or more hosted computing environments. The hosted computing environments may include a collection of rapidly provisioned and released computing resources hosted in connection with the domestic appliance communication system 100. Such computing resources may be referred to, individually, as host computing devices. The computing resources may further include a number of computing, networking and storage devices in communication with one another. In some embodiments, the computing devices may correspond to physical computing devices. In some embodiments, the computing devices may correspond to virtual machine instances implemented by one or more physical computing devices. In some embodiments, computing devices may correspond to both virtual computing devices and physical computing devices. A hosted computing environment may also be referred to as a cloud computing environment.

Each of the processes, methods, and algorithms described in the preceding sections may be embodied in, and fully or partially automated by, code modules executed by one or more computers, computer processors, or machines configured to execute computer instructions. The code modules may be stored on any type of non-transitory computer-readable medium or tangible computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

### Conclusion

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, and Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, and at least one of Z.

The terms “about,” “substantially,” and “generally” as used herein represent an amount close to the stated amount that still performs a desired function or achieves a desired result. For example, in some situations, as the context may dictate in accordance with the understanding of those of skill in the field, the term “generally” may refer to an amount or configuration that is within approximately 10% of the stated amount or feature, and the term “substantially” or “virtually” may refer to an amount or configuration that is within approximately 5% of the stated amount or feature.

For expository purposes, the term “horizontal” as used herein is defined as a plane generally parallel to the plane or surface of the floor of the area in which the device being described is used or the method being described is performed, regardless of its orientation. The term “floor” floor can be interchanged with the term “ground.” The term “vertical” refers to a direction generally perpendicular to the horizontal as just defined. Terms such as “above,” “below,” “bottom,” “top,” “side,” “higher,” “lower,” “upper,” “over,” and “under,” are defined with respect to the horizontal plane.

While the above detailed description has shown, described and pointed out novel features as applied to various embodiments, it can be understood that various omissions, substitutions and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes that come within the meaning and range of equivalency of the claims are to be embraced within their scope.

1.-21. (canceled)

22. A method for enabling reorder of custom trashcan liners, the method comprising:
providing a trashcan comprising:
a housing;
a receptacle portion configured to receive and store one or more objects; and
a dispenser portion configured to store one or more custom trashcan liners associated with the provided trashcan;
providing, to a user of the trashcan, an electronic user interface configured to enable the user to reorder the custom trashcan liners, wherein the electronic user interface comprises a user-selectable display element for selecting the custom trashcan liners, and wherein the user interface generates a communication regarding reordering the custom trashcan liners based at least partly on selection of the display element; and
providing the custom trashcan liners to the user based at least partly on the communication.

23. The method of claim 22, further comprising receiving data regarding a selected frequency with which to provide refills of the custom trashcan liners to the user, wherein providing the custom trashcan liners to the user based at least partly on the communication comprises providing a refill of the custom trashcan liners to the user in accordance with the selected frequency.

24. The method of claim 22, further comprising:
obtaining usage data regarding prior orders of the custom trashcan liners by the user; and
determining, based at least partly on the usage data, a predicted usage of the custom trashcan liners, wherein the user interface is further configured to display information regarding the predicted usage.

25. The method of claim 22, further comprising:
obtaining usage data regarding prior orders of the custom trashcan liners by the user;
determining, based at least partly on the usage data, a predicted usage of the custom trashcan liners;
determining, based on the predicted usage of the custom trashcan liners, to send a notification regarding reordering the custom trashcan liners; and
sending the notification.

26. The method of claim 22, further comprising determining a relative likelihood that the option is to be selected by users, wherein the user interface comprises an indication of the relative likelihood.

27. The method of claim 26, wherein determining the relative likelihood comprises:
obtaining usage data regarding prior orders of custom trashcan liners by a plurality of users; and
selecting, based at least partly on the usage data, the relative likelihood from a plurality of relative likelihoods that the option is to be selected by the plurality of users.

28. The method of claim 22, further comprising receiving, from the trashcan, a second communication regarding at least one of: an amount of custom trashcan liners used, or an amount of custom trashcan liners remaining in the dispenser portion.

29. The method of claim 22, further comprising receiving, from the trashcan, a second communication regarding at least one of: an amount of space occupied in the receptacle portion, or an amount of unused space remaining in the receptacle portion.

30. The method of claim 22, wherein providing the user interface comprises providing at least one of an application or a web site that is accessible by a computing device of the user.

31. The method of claim 22, further comprising:
determining a type of the trashcan, wherein the type comprises one of a plurality of different types of trashcans, and wherein the custom trashcan liners are customized for the type of the trashcan; and
storing information regarding the type of the trashcan, wherein providing the custom trashcan liners is based at least partly on the information regarding the type of the trashcan.

32. A custom trashcan liner reorder management system comprising:
a non-transitory computer-readable medium storing an application configured to cause a user computing device to at least:
display a user interface comprising:
a first input element configured to accept a first user selection of a type of custom trashcan liners to reorder;
a second input element configured to accept a second user selection of an amount of the custom trashcan liners to reorder; and
a third input element configured to accept a third user selection of a frequency with which the custom trashcan liners are to be delivered to a user;
receive, via the user interface, data representing the first user selection of the type of custom trashcan liners to reorder, the second user selection of the amount of the custom trashcan liners to reorder, and the third user selection of the frequency with which the custom trashcan liners are to be delivered to the user; and
transmit an electronic reorder message comprising data representing the type of the custom trashcan liners to reorder, the amount of the custom trashcan liners to reorder, and the frequency with which the custom trashcan liners are to be delivered to the user; and
a server system comprising one or more computing devices, wherein the server system is configured to at least:
receive the electronic reorder message;
determine, based at least partly on the frequency with which the custom trashcan liners are to be delivered to the user, to initiate delivery of amount of the custom trashcan liners to the user; and
initiate delivery of the amount of the custom trashcan liners to the user.

33. The system of claim 32, wherein the second input element comprises a user-selectable list of one or more predetermined amounts and corresponding prices.

34. The system of claim 32, wherein the third input element comprises a user-selectable list of one or more predetermined frequencies and corresponding descriptions indicating an approximate amount of users for which each predetermined frequency is recommended.

35. The system of claim 32, wherein user interface further comprises a fourth input element configured to receive a fourth user selection of a type of trashcan, and wherein the application further configures the user device to determine a type of custom trashcan liner based at least partly on the fourth user selection.

36. The system of claim 32, wherein the server system is further configured to at least:
obtain usage data regarding prior orders of custom trashcan liners by the user; and
determine, based at least partly on the usage data, a predicted usage of custom trashcan liners; and
transmit data representing the predicted usage to the user computing device.

37. The system of claim 32, wherein the server system is further configured to at least:
obtain usage data regarding prior orders of custom trashcan liners by the user;
determine, based at least partly on the usage data, a predicted usage of custom trashcan liners;
determine, based on the predicted usage of custom trashcan liners, to send a notification regarding reordering the custom trashcan liners; and
send the notification.

38. The system of claim 37, wherein the server system is further configured to determine a relative likelihood that the option is to be selected by users, wherein the user interface comprises an indication of the relative likelihood.

39. The system of claim 32, wherein the server system is further configured to at least:
obtain usage data regarding prior orders of custom trashcan liners by a plurality of users; and
select, based at least partly on the usage data, the relative likelihood from a plurality of relative likelihoods that the option is to be selected by the plurality of users.

40. The system of claim 32, further comprising a trashcan, wherein the trashcan comprises:
a housing;
a receptacle portion configured to receive and store one or more objects; and
a dispenser portion configured to store the custom trashcan liners, wherein the custom trashcan liners are configured for use with the trashcan.

41. The system of claim 40, wherein the trashcan further comprises:
a sensor configured to detect usage of custom trashcan liners; and
a network interface configured to transmit data regarding the usage of the custom trashcan liners.
